(19) United States
(12) Patent Application Publication
(10) Pub. No.: US 2025/0270141 A1
(43) Pub. Date: Aug. 28, 2025

(54) ULTRA-HIGH-PERFORMANCE CONCRETE PRODUCED USING OFF SPECIFICATION FLY ASH

(71) Applicant: The Trustees of the Stevens Institute of Technology, Hoboken, NJ (US)

(72) Inventors: Weina Meng, Warren, NJ (US); Yi Bao, Warren, NJ (US); Christos Christodoulatos, Basking Ridge, NJ (US); Jiang Du, Hoboken, NJ (US)

(73) Assignee: The Trustees of the Stevens Institute of Technology, Hoboken, NJ (US)

(21) Appl. No.: 18/855,240

(22) PCT Filed: Apr. 11, 2023
(86) PCT No.: PCT/US2023/018207

§ 371 Date: Oct. 8, 2024

Related U.S. Application Data
(60) Provisional application No. 63/329,820, filed on Apr. 11, 2022.

(51) Int. Cl. C04B 28/04; C04B 14/06; C04B 14/48; C04B 16/06; C04B 18/06; C04B 24/26; C04B 103/30

(52) U.S. Cl. CPC C04B 28/04; C04B 14/06; C04B 14/48; C04B 16/0641; C04B 18/067; C04B 24/2647; C04B 2103/302

(57) ABSTRACT

The present invention relates to the manufacture and use of off-specification fly ash (OSFA), which would have otherwise been landfilled, in preparing ultra-high-performance concrete (UHPC). The present invention aims to provide a new avenue for valorization of OSFA in the concrete industry by utilizing high-volume OSFA in producing UHPC. Compared with conventional concrete and high-performance concrete, UHPC is a family of advanced concrete featuring exceptional compressive strength, ductility, and long-term durability. Application in UHPC is expected to be a new and feasible technology to efficiently recycle OSFA.

### CROSS-REFERENCE TO RELATED APPLICATION

This application claims the benefit of and priority to U.S. Provisional Patent Application Ser. No. 63/329,820 filed Apr. 11, 2022, the entire disclosure of which is incorporated herein by reference.

### STATEMENT REGARDING FEDERALLY SPONSORED RESEARCH

This invention was made with government support under Award No. CMMI-2046407 awarded by the National Science Foundation and Contract No W91278-16-D-0007 awarded by the U.S. Army Corps of Engineers Mobile District via SIA Solutions, LLC. The U.S. government has certain rights in the invention.

### FIELD OF THE INVENTION

The invention relates to construction materials that can be used to build different civil engineering structures, such as bridges, tunnels, buildings, pipes, and roads. Specifically, the present invention relates to construction materials utilizing off-specification fly ash (OSFA), which is a family of solid waste that is traditionally landfilled and may pollute soil and underground water. Government transportation and/or environmental agencies as well as private companies in the construction industry, particularly concrete and cement companies, could take advantage of the present invention.

### BACKGROUND OF THE INVENTION

Fly ash is a by-product produced by burning pulverized coal in electric generation power plants. Fly ash has been used to prepare cement-based construction materials such as Portland cement concrete, which is utilized in different types of engineering structures such as bridges, tunnels, buildings, and roads. In general, fly ash contains species that react with water and cement through hydraulic and/or pozzolanic reactions, which improve mechanical properties and durability of structures if concrete is well designed and prepared. Typically, fly ash has fine and round particles that improve fresh properties such as the flowability of concrete. According to ASTM C618, there are two main types of fly ash that can be used to prepare cement-based materials, which are Class C and Class F fly ash. In general, Class C fly ash is more reactive than Class F fly ash with water. Both Class C and Class F fly ash are classified as specification-grade fly ash that has been well accepted by construction industries. Currently, more than 50% of concrete in the U.S. contains fly ash. In addition to the benefits of fresh and hardened properties of concrete, in general, use of fly ash reduces material cost, carbon emissions, and embodied energy.

Fly ash is a pozzolan byproduct of coal in power plants. It contains both aluminous and siliceous material that forms cement when mixed with water. When fly ash is mixed with lime and water, it creates a strong compound that is comparable to Portland cement.

ASTM C618 defines two classes of fly ash for use in concrete: Class F and Class C. ASTM C618 also delineates requirements for the physical, chemical, and mechanical properties for these two classes of fly ash. Furthermore, the ASTM C618 standard provides information on the physical, chemical, and mechanical properties of the fly ash classes.

Class C (Cementitious) fly ash is derived from lignite or sub-bituminous coal. It contains a higher percentage of calcium oxide with a carbon content of less than 2 percent. This class of fly ash has self-cementing and pozzolanic properties.

Class F (Pozzolanic) fly ash is derived from burning anthracite or bituminous coal. It generally contains less calcium oxide compared to Class C fly ash. This class contains less than 5 percent of carbon content, but it can also be as high as 10 percent. It contains little to no cementing properties.

With an appropriate proportion of fly ash, the fresh and hardened properties of concrete can be significantly improved. For example, fly ash improved the flowability, mechanical strengths, and durability of concrete. In addition, employment of fly ash can reduce material cost as well as environmental impacts in terms of carbon footprint and embodied energy. Fly ash has been used in more than 50% of concrete in the U.S.

However, only a portion of fly ash that satisfies specification requirements can be used in cement or cement-based materials. This is a main reason for the limited usage percentage of fly ash. Off-specification fly ash (OSFA) that does not satisfy the specification requirements is landfilled. The problem of low usage percentage of fly ash was exacerbated in recent years by the increased production of OSFA in the U.S. Due to the increasingly stringent environmental policy stipulated by the Environmental Protection Agency (EPA), many power plants have adopted new types of burners with low emission of nitrogen oxides (NOₓ) and sulfur oxide (SOₓ). The new types of burners reduced generation of NOₓ, SOₓ, and mercury, but significantly increased the volume ratio of carbon in fly ash, producing more OSFA. Such changes also reduced the amount of specification-grade fly ash used in concrete industry, causing a shortage of available fly ash in concrete industry. Cumulative production of OSFA imposes challenges, as the available area for landfill is shrinking in many major cities. Recycling of OSFA is relevant to the policy aspect for conservation of the environment.

Currently, the use of ultra-high-performance concrete (UHPC) is mainly limited to special structural elements, such as joints in bridges subjected to large and complicated loadings, because the upfront cost of UHPC is high. The unit cost of UHPC is more than ten times higher than that of conventional concrete. Although cost-effective UHPC has been developed in recent years through optimizing the mixture design and using supplementary cementitious materials such as fly ash, slag, and waste glass, the cost of UHPC is still high and hinders wider acceptance in structures.

### SUMMARY OF THE INVENTION

The present invention is a composition of materials. Similar to concrete, the composite is made by mixing multiple ingredients and undertaking various process steps. These ingredients include multiple powders and liquids. After mixing, the material is cured and gets hardened. Once hardened, the material can bear loads and provide multiple added functions.

The invention uses off-specification fly ash that contains a high content of elemental carbon. For the purposes of this application, OSFA will be defined as Fly Ash not falling into the Class C or Class F categories defined above. The invention represents the first UHPC made using OSFA. The invention achieves superior material properties, including the following: Regarding constructability, the present invention is self-flowable. During construction, no vibrator is needed to consolidate the material. The construction process will be simplified and reduced. The construction quality also will be improved. According to laboratory experiments, the compressive strength at 28 days is relatively high at about 121.5 MPa. The high compressive strength is important because the load-carrying capability of engineering structures is directly related to the strength. Consequently, under a given load, the safety will be improved relative to established materials. The present invention has also shown high crack resistance. Specifically, the cracking strength was more than two times the cracking strength of normal concrete. High ductility and toughness was also shown, meaning the present invention can bear higher load after it is cracked. Under earthquakes or impacts, more energy can be dissipated without collapsing the structure. High durability was also exhibited, and the invention has a very dense microstructure with a low permeability. This means that it is difficult and slow for harmful matters to penetrate into the material. Moreover, the present invention has a self-healing property, so microcracks can be self-healed over time. Finally, the present invention shows multifunctionality. Specifically, materials made in accordance with an embodiment of the present invention have self-sensing and self-heating properties. This means that damages in the material can be sensed and the temperature of the material can also be controlled.

Compared with present technology of using OSFA, the present invention achieves very high performance, in terms of the constructability, compressive strength, crack resistance, ductility and toughness, durability, and multifunctionality. Compared with present UHPC, the invention utilizes OSFA, which is a by-product that has never been used in UHPC to date.

The invention solves two main problems: First, it provides a new way to utilize OSFA, which is an industrial by-product that is commonly landfilled. Additionally, it provides a new way to produce UHPC, which currently has a high material cost that hinders the applications in engineering structures. The invention represents a sustainable and resilient material for civil infrastructure. The invention also can be used to manufacture precast structural elements, which then can be used in construction.

In an embodiment of the present invention, the OSFA has a SiO2 content of approximately 16.72%, an Al2O3 content of approximately 10.18%, and a Fe2O3 content of approximately 6.66%. In other embodiments, the loss of ignition (LOI) of the OSFA is approximately 49.8%, while its carbon content is approximately 41.8%.

The economic and environmental evaluations of using OSFA in preparing UHPC showed the great benefits in environmental conservation and waste resource recycling.

### BRIEF DESCRIPTION OF THE DRAWINGS

For a more complete understanding of the present invention, reference is made to the following detailed description of embodiments considered in conjunction with the accompanying drawings, in which: FIG. 1. is a schematic diagram illustrating UHPC mixing procedures;

FIG. 2a shows compressive strength results with varying OSFA content and water-to-binder ratios;

FIG. 2b shows compressive strength results with varying slag content;

FIG. 3a shows load-displacement curves for different OSFA contents;

FIG. 3b shows flexural strength and toughness results for different OSFA contents;

FIG. 3c shows load-displacement curves for different water-to-binder ratios;

FIG. 3d shows flexural strength and toughness for different water-to-binder ratios;

FIG. 3e shows load-displacement curves for different slag contents;

FIG. 3f shows flexural strength and toughness results for different slag contents;

FIG. 4a shows autogenous shrinkage results of investigated UHPC mixtures based on OSFA content;

FIG. 4b shows autogenous shrinkage results of investigated UHPC mixtures based on slag content;

FIG. 5a shows results of thermogravimetric analysis (TGA) tests illustrating the effects of OSFA content and water-to-binder ratio on mass loss;

FIG. 5b shows the results of TGA tests showing the effect of slag content on mass loss;

FIG. 5c shows the results of TGA tests showing the effects of OSFA content and water-to-binder ratio on mass loss rate;

FIG. 5d shows the results of TGA tests showing the effect of slag content on mass loss rate;

FIG. 5e shows the results of TGA tests showing the bounded water content;

FIG. 5f shows the results of TGA tests showing the CH content;

FIG. 6a is a characterization of morphology and particle size of off-specification fly ash in the form of a SEM image;

FIG. 6b is a characterization of the particle sizes of off-specification fly ash in the form of a particle size gradation graph;

FIG. 7 is graphical results of the strength activity indices of the control samples and OSFA samples;

FIG. 8a is a characterization of the investigated OSFA showing the TGA result;

FIG. 8b is a characterization of the investigated OSFA showing the X-ray Diffraction (XRD) result;

FIG. 9a shows flowability results relating to a mini-slump spread of mixtures with different OSFA contents and fixed high-range water reducer (HRWR) content;

FIG. 9b shows flowability results relating to a mini-slump spread of mixtures with different HRWR demand with a fixed mini-slump spread;

FIG. 10a shows the effects of OSFA content and water-to-binder ratio on hydration heat in accordance with an embodiment of the present invention;

FIG. 10b shows the effects of slag content on hydration heat in accordance with an embodiment of the present invention;

FIG. 11 shows results of the XRD tests of mixtures OSFA20 and OSFA20SL40 (20 from 5° to 65°);

FIG. 12 illustrates results of unit carbon footprint and strength-normalized carbon footprint of the investigated mixtures in accordance with an embodiment of the present invention;

FIG. 13 shows results of the energy consumption and strength-normalized energy consumption of the investigated mixtures in accordance with embodiments of the present invention;

FIG. 14a shows the mini-slump spread of mixtures M1 to M4 with different OSFA contents;

FIG. 14b shows the plastic viscoscity and dynamic yield stress base on the Bingham model for mixtures M1 to M4 with different OSFA contents;

FIG. 14c shows the plastic viscosity for mixtures M1 to M4 with different OSFA contents;

FIG. 15a shows the effects of the OSFA content on compressive strength in accordance with an embodiment of the present invention;

FIG. 15b shows the effects of the OSFA content on flexural test curves in accordance with an embodiment of the present invention;

FIG. 15c shows the effects of the OSFA content on ultimate flexural strength in accordance with an embodiment of the present invention;

FIG. 15d shows the effects of the OSFA content on flexural deflection in accordance with an embodiment of the present invention;

FIG. 15e shows the effects of the OSFA content on the flexural deformation of a sample made using mixture M2 under loading in accordance with an embodiment of the present invention;

FIG. 15f shows the distributions of crack width of mixtures M1 to M4 in accordance with an embodiment of the present invention;

FIG. 16al shows the effect of fiber content on compressive strength;

FIG. 16a2 shows the effect of fiber content on flexural properties of Strain-hardening Cementitious Composites (SHCC);

FIG. 16b1 shows the effect of water-to-binder ratio (w/b) on compressive strength;

FIG. 16b2 shows the effect of water-to-binder ratio (w/b) on flexural properties of SHCC;

FIG. 16c1 shows the effect of sand-to-binder ratio (s/b) on compressive strength;

FIG. 16c2 shows the effect of sand-to-binder ratio (s/b) on flexural properties of SHCC;

FIG. 17 illustrates the effect of the OSFA content on the hydration kinetics of cement pastes with the OSFA in accordance with an embodiment of the present invention;

FIG. 18a shows results of TGA tests with respect to the cumulative mass loss;

FIG. 18b shows results of TGA tests with respect to the differential mass loss;

FIG. 18c shows results of TGA tests with respect to the content of bonded water;

FIG. 18d shows results of TGA tests with respect to the content of calcium hydroxide;

FIG. 19 shows the XRD test results of the mixtures M1 and M2 with different OSFA contents;

FIG. 20 shows calculated results of the carbon footprint of investigated SHCC mixtures in connection with embodiments of the present invention;

FIG. 21 shows calculated results of the embodied energy of investigated SHCC mixtures in connection with embodiments of the present invention;

FIG. 22 shows a graphical characterization of the investigated OSFA with respect to the TGA test result;

FIG. 23a shows a test protocol for an equilibrium flow curve for a rheology test in accordance with an embodiment of the present invention;

FIG. 23b shows a Bingham model of the equilibrium flow curve of FIG. 23a; and

FIG. 24 shows the results of the unit cost and strength-normalized cost of the investigated mixtures in accordance with an embodiment of the present invention.

### DETAILED DESCRIPTION OF THE EXEMPLARY EMBODIMENT

The following disclosure is presented to provide an illustration of the general principles of the present invention and is not meant to limit, in any way, the inventive concepts contained herein. Moreover, the particular features described in this section can be used in combination with the other described features in each of the multitude of possible permutations and combinations contained herein.

All terms defined herein should be afforded their broadest possible interpretation, including any implied meanings as dictated by a reading of the specification as well as any words that a person having skill in the art and/or a dictionary, treatise, or similar authority would assign thereto.

Further, it should be noted that, as recited herein, the singular forms “a”, “an”, “the”, and “one” include the plural referents unless otherwise stated. Additionally, the terms “comprises” and “comprising” when used herein specify that certain features are present in that embodiment, however, this phrase should not be interpreted to preclude the presence or addition of additional steps, operations, features, components, and/or groups thereof.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In an embodiment of the present invention Type I Portland cement, OSFA from a power plant, silica sand, steel fibers, chemical admixtures, and tap water can be used as raw materials. The cement, slag, and OSFA can be used as the binders. Silica sand can be used as the fine aggregate. A polycarboxylate-based high-range water reducer (HRWR) can be used to improve the flowability.

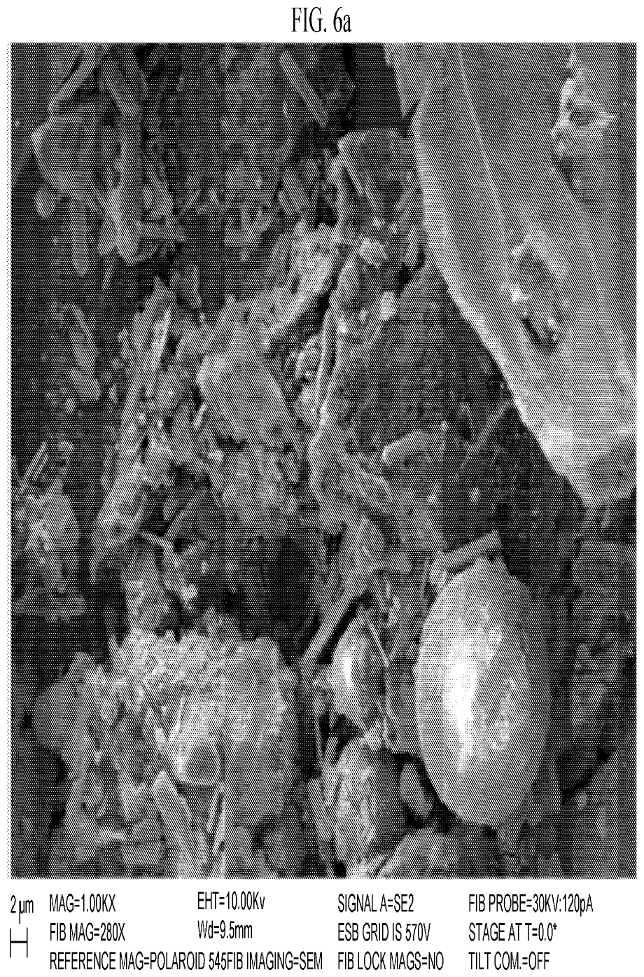

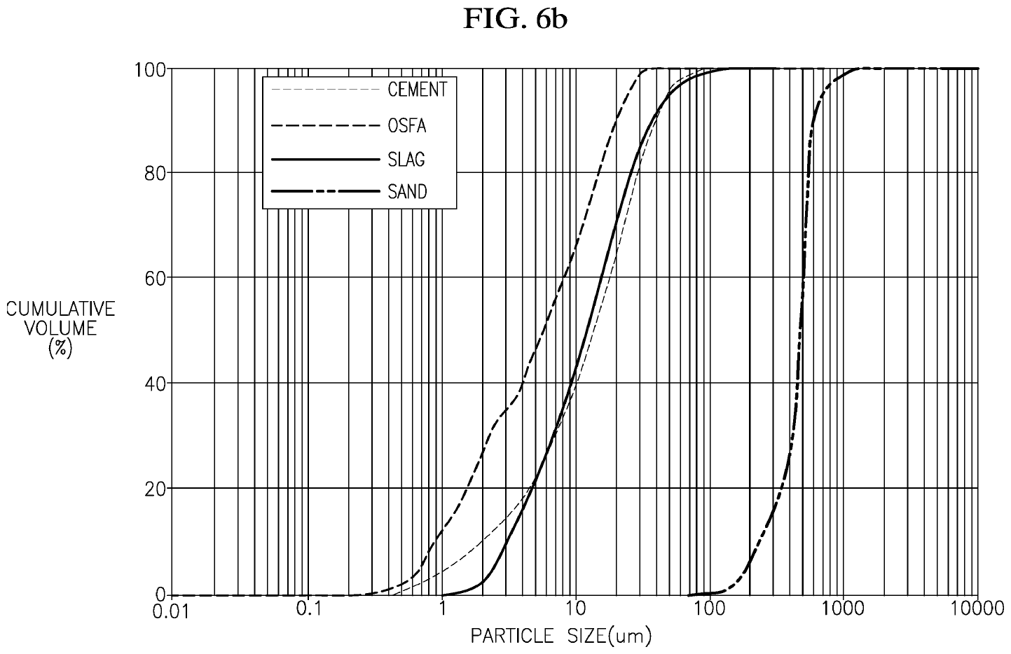

The chemical compositions of the Type I Portland cement and OSFA ash were characterized by X-ray fluorescence (XRF) and XRD, as listed in Table Si below. The particle size distribution of the cement, OSFA, and sand are presented in FIG. 6b. Characteristics of the OSFA including morphology, loss on ignition, and mineral composition are introduced in the Raw Materials Section of Example 2 below.

The solid content and specific gravity of the HRWR are 34.4% and 1.05, respectively. Steel fibers measuring 0.2 mm in diameter and 13 mm in length can be used as a tension reinforcement to enhance the crack resistance. The tensile strength and modulus of elasticity of the steel fibers are 1.9 GPa and 203 GPa, respectively. Tap water can be as the mixing water.

A mixer (model: Hobart® HL-200) with a volume capacity of 19 L was used to mix raw materials for preparation of the mixtures. The mixing procedure of the present invention includes four main steps: (1) The dry ingredients (cement, slag, OSFA, and sand) are introduced to the mixer and mixed at 1 rps for 2 minutes (min). (2) The HRWR is dissolved in the mixing water to form a solution, and 90% of the solution is introduced to the mixer and mixed at 1 rps for 3 min. (3) The rest of solution is added, and the mixture is mixed at 2 rps for 3 min. (4) The steel fibers are added to the mixer and mixed at 2 rps for 2 min. After mixing, the mixtures were examined by hand, and no fiber agglomeration or segregation was found. A schematic diagram of the UHPC mixing procedures is shown in FIG. 1.

Immediately after mixing, the mixtures were used to cast three types of specimens, which are cubic specimens for compressive test, beam specimens for flexural test, and tube specimens for shrinkage test.

During casting, although the mixtures were self-flowable, the molds were placed on a vibration table to ensure a high casting quality. Immediately after casting, the specimens were covered by wet burlap and plastic sheet. The specimens were demolded after 1 d, and then cured in lime-saturated water at room temperature (23±2° C.) until testing.

The flowability of the investigated mixtures was evaluated through mini-slump flow test, in accordance with ASTM C230. The mini-slump flow test was used to adjust the HRWR content to secure self-consolidating property of the mixtures.

Table 1 lists the ten mixtures investigated in this study. The mixtures were designed based on a cost-effective UHPC developed in previous research. Three important mix design variables were studied, which are the OSFA content (10%, 20%, and 30%, by volume of binder), water-to-binder ratio (0.23, 0.21, and 0.19, by mass), and slag content (20%, 30%, 40%, and 60%, by volume of binder). The binder-to-sand ratio was fixed at 1:1, by volume.

TABLE 1
Mixture proportions of UHPC (kg/m³)

| | | | | | | | Steel |
|---|---|---|---|---|---|---|---|
| Mixture | Cement | OSFA | Slag | Sand | HRWR | Water | fiber |
| Control | 1133.1 | 0 | 0 | 953.2 | 5.8 | 260.8 | 156.0 |
| OSFA10 | 1034.6 | 52.9 | 0 | 967.1 | 5.6 | 250.0 | 156.0 |
| OSFA20 | 933.2 | 107.4 | 0 | 981.4 | 5.6 | 239.4 | 156.0 |
| OSFA30 | 828.8 | 163.5 | 0 | 996.1 | 5.5 | 228.2 | 156.0 |
| OSFA20-21 | 953.5 | 109.7 | 0 | 1002.7 | 6.5 | 224.9 | 156.0 |
| OSFA20-19 | 974.6 | 112.2 | 0 | 1024.9 | 8.0 | 210.6 | 156.0 |
| OSFA20SL20 | 703.0 | 107.9 | 215.7 | 985.7 | 4.3 | 235.7 | 156.0 |
| OSFA20SL30 | 587.1 | 108.1 | 324.3 | 987.8 | 4.3 | 234.0 | 156.0 |
| OSFA20SL40 | 470.7 | 108.3 | 433.3 | 990.0 | 4.2 | 232.4 | 156.0 |
| OSFA20SL60 | 236.4 | 108.8 | 652.9 | 994.3 | 4.2 | 229.0 | 156.0 |

Note:
The saturation dosages of HRWR are listed for comparison with the HRWR contents.

Through experimental testing, it was found that the addition of OSFA improved the flowability of UHPC mixtures. As the OSFA content increased from 0 to 30%, the mini-slump spread was increased from 230 mm to 290 mm (by 26%). The improvement was attributed to the finer OSFA particles compared with cement. Additionally, use of OSFA reduced the compressive strength, flexural strength, and toughness of UHPC because OSFA retarded hydration reactions. As the OSFA content increased from 0 to 30%, the compressive strength was reduced from 104.7 MPa to 77.1 MPa (by 26%), the flexural strength was reduced from 27.5 MPa and 17.6 MPa (by 36%), and the toughness was reduced from 7.8 kN·mm to 5.0 kN·mm (by 36%).

Furthermore, the use of slag suppressed the adverse effects of OSFA on the compressive strength, flexural strength, and toughness through promoting pozzolanic reactions. With a slag content of 40% by binder volume, the mixture achieved compressive strength, flexural strength, and toughness of 121.4 MPa, 27.1 MPa, and 7.3 kN·mm, respectively.

It was further found that the use of OSFA reduced the autogenous shrinkage of UHPC mixtures. As the OSFA content increased from 0 to 30%, the autogenous shrinkage decreased from 1089με to 593με (by 46%). With incorporation of slag at 60% by volume of binder, the autogenous shrinkage was 662με, which is reasonably low for UHPC mixtures.

Based on the life-cycle assessment of economic and environmental features of UHPC with OSFA, the developed UHPC mixtures demonstrate significant benefits from the perspective of sustainability and economy. With the optimal mixture with an OSFA content of 20% and slag content of 40%, the estimated life-cycle cost, carbon footprint, and embodied energy were reduced to 909 dollar/m³, 651 kg/m³, and 6471 MJ/m³. In addition, the leaching of heavy metals from the UHPC mixtures is negligible, as shown in Table 2.

TABLE 2
Heavy metal leaching results

| Heavy metals | As | | Pb | | Se | |
|---|---|---|---|---|---|---|
| OSFA powder | 0.78 | ppm | <0.1 | ppm | 0.22 | ppm |
| OSFA20 | <0.1 | ppm | <0.1 | ppm | <0.1 | ppm |
| OSFA20-21 | <0.1 | ppm | <0.1 | ppm | <0.1 | ppm |
| OSFA20SL40 | <0.1 | ppm | <0.1 | ppm | <0.1 | ppm |
| OSFA20SL60 | <0.1 | ppm | <0.1 | ppm | <0.1 | ppm |
| Allowable limitations | 5 | ppm | 5 | ppm | 1 | ppm |

Compared with other UHPC mixtures proposed in recent years, the developed UHPC mixture in this study, such as OSFA20SL40, shows great potential in developing green and cost-effective UHPC.

### Example 1

### Raw Materials

Type I Portland cement was adopted. Slag from a local plant in New Jersey and OSFA from a power plant in Tennessee were employed as supplementary cementitious materials used to partially replace cement. Masonry sand was used as the fine aggregate. The chemical composition of the dry ingredients was characterized by X-ray fluorescence (XRF) and XDR, as listed in Table B1.

TABLE B1
Chemical and physical properties of raw materials

| | Type I Portland cement | Slag | OSFA | Sand |
|---|---|---|---|---|
| SiO₂ (%) | 22.44 | 36.21 | 16.72 | 86.50 |
| Al₂O₃ (%) | 2.76 | 11.10 | 10.18 | 0.39 |
| Fe₂O₃ (%) | 2.24 | 0.76 | 6.66 | 1.47 |
| CaO (%) | 68.05 | 43.75 | 2.41 | 9.42 |
| MgO (%) | 0.91 | 5.09 | 0.90 | — |
| SO₃ (%) | 2.25 | 2.21 | 3.89 | — |
| Na₂O (%) | 0.19 | 0.23 | 0.25 | — |
| K₂O (%) | 0.11 | 0.40 | 1.24 | — |
| TiO₂ (%) | 0.14 | 0.58 | 0.49 | — |
| P₂O₅ (%) | 0.09 | 0.02 | 0.30 | — |
| Mn₂O₃ (%) | 0.03 | 0.36 | 0.01 | — |
| SrO (%) | — | 0.10 | — | — |
| C₃S (%) | 62.35 | — | — | — |
| C₂S (%) | 20.28 | — | — | — |
| C₃A (%) | 1.42 | — | — | — |
| C₄AF (%) | 5.83 | — | — | — |
| Loss on ignition (%) | 1.28 | 0.72 | 49.8 | 0.24 |
| Specific gravity, SSD | 3.15 | 2.90 | 1.45 | 2.64 |

The scanning electronic microscopy (SEM) image shows round particles and irregular particles, as shown in FIG. 6a. The OSFA has different morphology from Class C and Class F fly ash that have round particles. The particle size distribution curves of the cement, slag, OSFA, and sand are plotted in FIG. 6b.

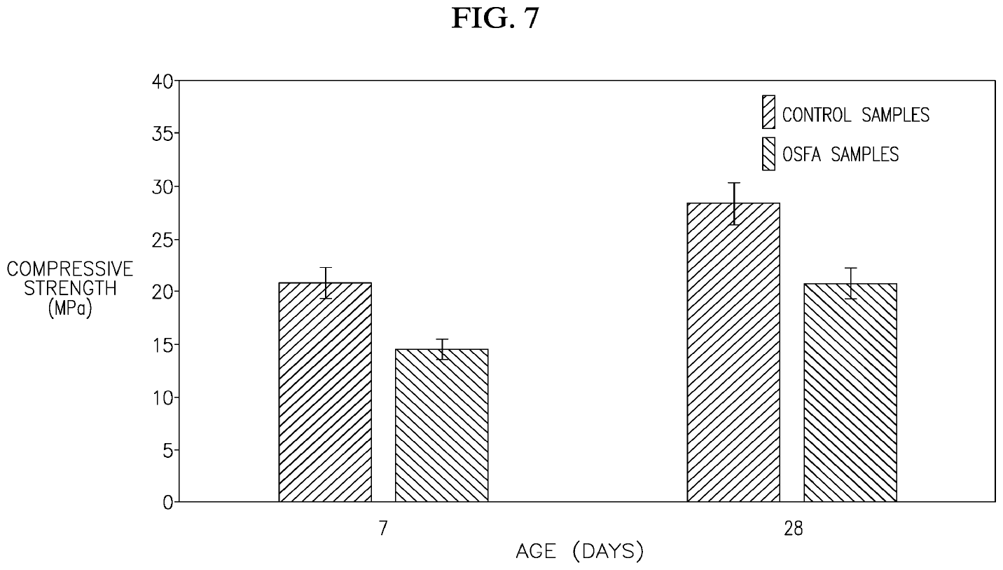

The pozzolanic activity of OSFA was evaluated by the strength activity index and the Chapelle test. The strength activity index test was conducted in accordance with BS 3892. The control mortar cubes were prepared by mixing 1350 g sand, 450 g cement, and 225 ml water. To prepare the test mortar cubes, 20% cement was replaced using the OSFA. The strength activity index is the compressive strength ratio of the test samples and control samples. The strength activity indices were 0.70 at 7 days (d) and 0.73 at 28 d, as shown in FIG. 7. The Chapelle test was conducted in accordance with NF P18-513. The consumption of Ca(OH)2 by 1 g OSFA was quantified. The suspension of 1 g OSFA, 1 g CaO, and 250 mL distilled water was boiled at 90° C. for 16 hours (h) of continuous stirring. The unconsumed Ca(OH)2 content (free in solution) was quantified by acid titration. The pozzolanic activity of OSFA was expressed as 353.1 mg Ca(OH)2/g OSFA. In comparison, the 28-d strength activity index is 0.80 and the Chapelle test result is 436 mg Ca(OH)2/g fly ash for specification-grade fly ash, respectively, in compliance with ASTM C618. The results consistently indicate that the OSFA has lower pozzolanic reactivity than the specification-grade fly ash.

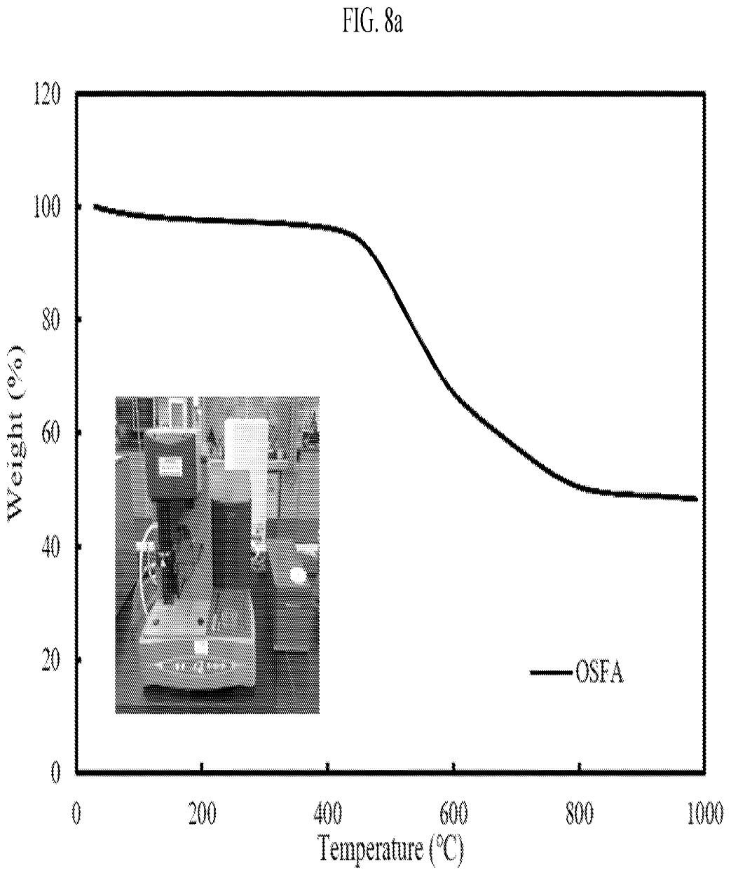

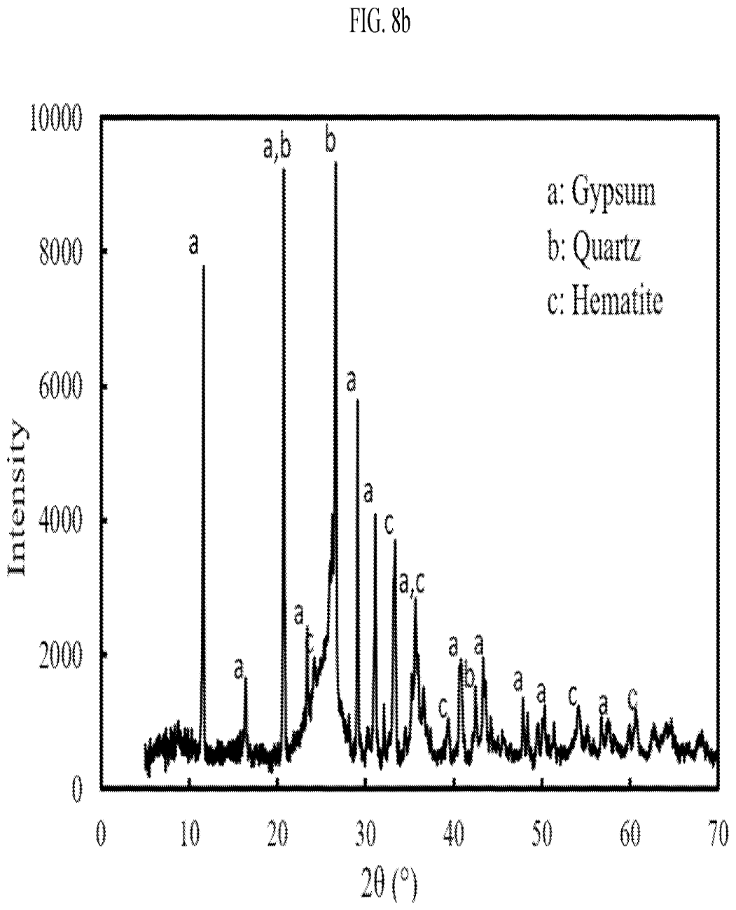

According to ASTM C618, the upper limit of loss on ignition of Class C and Class F is 6%, which is much lower than the loss on ignition (49.8%) of the OSFA in this study. To evaluate the loss on ignition, this research performed a TGA using a thermogravimetric analyzer (model: TA® TG55). During the test, air was input to a chamber of the TGA analyzed with OSFA sample at a constant flow rate of 50 ml/min. The TGA test results are shown in FIG. 8a. As temperature was increased from 20° C. to 1000° C., the mass loss of OSFA sample was increased from 0 to 49.8%. The mass loss is mainly attributed to presence of elemental carbon and gypsum in the OSFA. After the TGA test, a combustion test was conducted to characterize the carbon content. It was found that elemental carbon accounted for 41.8% of the mass of OSFA, which is 84% of the loss on ignition of the OSFA. The remaining 16% of loss of ignition can be attributed to partial decomposition of gypsum at elevated temperatures. The XRD results are shown in FIG. 8b. The main minerals of OSFA include gypsum, quartz, and hematite. The mass percentages of gypsum, quartz, and hematite were 51.7%, 3.2%, and 45.1%.

### Mixture Design

Table 1 lists the ten mixtures investigated in this study. Three important mix design variables were studied, which are the OSFA content (10%, 20%, and 30%, by volume of binder), water-to-binder ratio (0.23, 0.21, and 0.19, by mass), and slag content (20%, 30%, 40%, and 60%, by volume of binder). The binder-to-sand ratio was fixed at 1:1, by volume.

A polycarboxylate-based high-range water reducer (HRWR) was used to improve the flowability of the mixtures. The solid content and specific gravity of the HRWR are 34.4% and 1.05, respectively. The HRWR contents of the investigated mixtures were adjusted to ensure that the mixtures were self-flowable. Meanwhile, appropriate rheological properties such as plastic viscosity allow for the achievement of appropriate fiber dispersion and orientation. To enhance the crack resistance and toughness, chopped steel fibers measuring 0.2 mm in diameter and 13 mm in length were incorporated. The tensile strength and modulus of elasticity of the steel fibers are 1.9 GPa and 203 GPa, respectively.

### Fresh and Hardened Properties

The flowability of the investigated mixtures above was evaluated through mini-slump flow tests, in accordance with ASTM C230. The mini-slump flow test was used to adjust the HRWR content to secure self-consolidating property of the mixtures.

The compressive strength was evaluated through uniaxial compressive tests using 50-mm cubes, in accordance with ASTM C109. The loading rate was kept constant at 1.8 kN/min. The compressive tests were conducted at 1, 3, 7, 14, and 28 days.

The flexural properties were evaluated through four-point bending tests in accordance with ASTM C1609. The test specimens measured 280 mm×76 mm×25 mm. The loading span length was 94 mm. The bending tests were conducted using a load frame (model: Instron® 5982) under displacement control. The displacement rate was 0.05 mm/min. The tests were performed to evaluate the flexural strength and energy dissipation at 7 days and 28 days. The flexural strength was calculated using Eq. (1):

$$σ = \frac{3 F ( L - {L}_{i} )}{2 {bd}^{2}} \qquad ( 1 )$$

where F, L, Li, b, and d are the peak load, distance between supports (L=240 mm), distance between loads (Li=94 mm), beam width, and beam depth, respectively. The area between the load-deflection curve and horizontal axis (from 0 to L/40) is the energy dissipation capability.

### Hydration Heat

The heat of hydration of each mixture was evaluated using an isothermal calorimeter (model: Calmetrix® I-Cal 4000 HPC), which was programmed to maintain the sample at 25° C. About 60 g of fresh mixture was sealed in a plastic vial and placed in the calorimeter. The heat of hydration was continuously measured from 2 min after completion of mixing until 48 hours. The results were normalized by the mass of binder.

### Autogenous Shrinkage

The autogenous shrinkage was evaluated according to ASTM C1698. Due to the low water-to-binder ratio, UHPC features large autogenous shrinkage, which may cause cracks and debonding in structures. Cracks and debonding can highly compromise the mechanical properties and durability of structures. The present example evaluated the autogenous shrinkage of the investigated UHPC mixtures using tube specimens. The specimens were cast in corrugated plastic tubes and stored at a constant temperature (23° C.±1° C.) and relative humidity (50%±1%). Length change of the specimens was measured and used to calculate the autogenous shrinkage. The first measurement was carried out at 12 hours after casting, then on a daily basis for the first week, and finally on a weekly basis until 28 days.

### Thermogravimetry Analysis

Thermogravimetric analysis (TGA) was carried out using a thermal analyzer (model: TA® TG55) to evaluate the hydration kinetics of the mixtures. For the sample preparation, 50 mg of samples from dried slices (after stopping hydration with isopropanol) was crushed into fine powders and vacuum dried 24 h before the test. During the test, the sample was heated at a constant rate of 20° C./min from 20° C. to 1000° C. in a 50 ml/min flow of nitrogen.

### X-Ray Diffraction

X-ray diffraction (XRD) test was carried out using a diffractometer (model: Panalytical X' pert Pro) to evaluate the hydration products of the mixtures. The sample preparation was the same as that in the Thermogravimetry test above. During the XRD test, powder samples were scanned on a rotating stage between 5° and 65° (2θ) using an X'Celerator detector. The step size of scanning was 0.0167° (2θ), and the time per step was 30 seconds.

### Leaching of Heavy Metals

Leaching of heavy metals from OSFA and UHPC was evaluated by toxicity characteristic leach procedure (TCLP) tests and compared with regulatory limitations. Sample solutions were prepared using OSFA powder and crushed UHPC, in accordance with Toxicity Characteristic Leaching Protocol, E P A, 1992, with a liquid-to-solid ratio of 20. The samples were stored in polyethylene bottles tumbled at a speed of 30 rpm for 18 h and then vacuum filtered using 0.6 μm to 0.8 μm glass fiber filters. The filtered samples were collected for measuring heavy metal ions using inductively coupled plasma-optical emission spectrometry (ICP-OES). Heavy metals arsenic (As), lead (Pb), and selenium (Se) in the OSFA were higher than the allowable limits, as shown in Table B2 below. Thus, leachability of the UHPC mixtures was investigated in this research.

TABLE B2
Heavy metal contents and allowable leaching limits in TCLP test

| Heavy metals | As | | Pb | | Se | |
|---|---|---|---|---|---|---|
| OSFA | 518 | ppm | 116 | ppm | 360 | ppm |
| Allowable leaching limits | 5 | ppm | 5 | ppm | 1 | ppm |

### Flowability

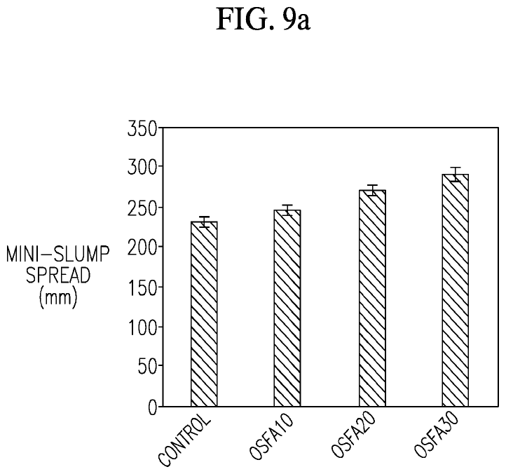

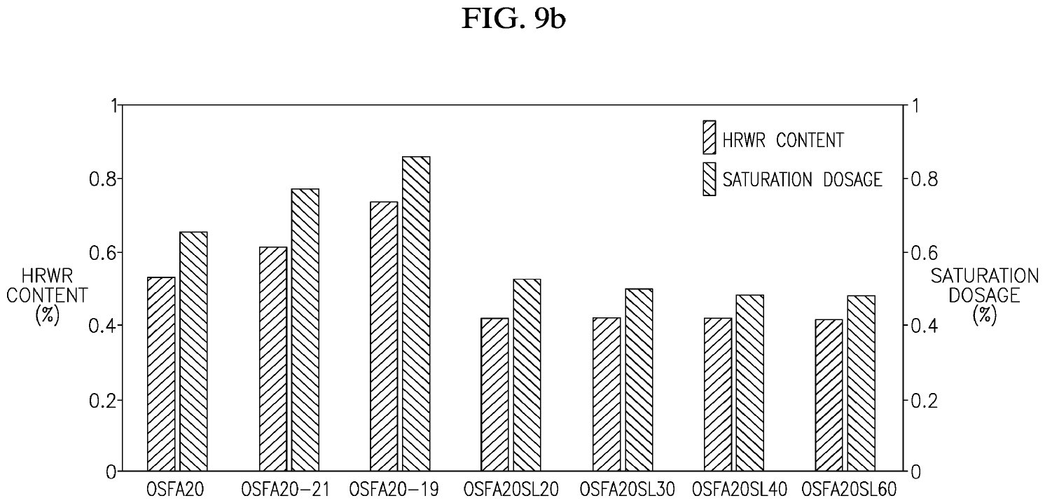

The effect of OSFA on flowability of the mixtures was evaluated by a mini-slump flow test. First, the HRWR content was fixed at 0.52% by mass of binder. As the OSFA content increased from 0 to 30%, the mini-slump spread was increased from 230 mm to 290 mm (by 26%), as shown in FIG. 9a. The results indicated that the addition of OSFA improved the workability of UHPC which is attributed to the finer particles of the OSFA compared with cement particles.

Then, the mini-slump spread was controlled at 280±20 mm for the rest of the mixtures by adjusting the HRWR content to achieve self-consolidation. For example, as the water-to-binder ratio decreased from 0.23 to 0.19, the HRWR demand was increased from 0.53% to 0.73%. As the slag content increased from 0 to 60%, the HRWR demand was sustained at a low level. The saturation dosage of superplasticizer or HRWR was evaluated by mini-slump flow tests according to ASTM C1437. The results of the saturation dosage of HRWR are listed in Table 1. The HRWR content of each mixture was lower than the saturation dosage, as shown in FIG. 9b. The HRWR content was controlled to achieve desired flowability while preventing segregation. When the HRWR content is too high, the viscosity of the UHPC will be too low to homogenize the raw materials. Specifically, the OSFA with low density will float to the top surface, and the steel fibers with high density will sink to the bottom. The optimal HRWR content was determined to achieve appropriate plastic viscosity. Throughout the flowability tests of the investigated UHPC mixtures, no segregation was observed. The desired flowability is attributed to the appropriate plastic viscosity of the mixtures.

### Compressive Strength

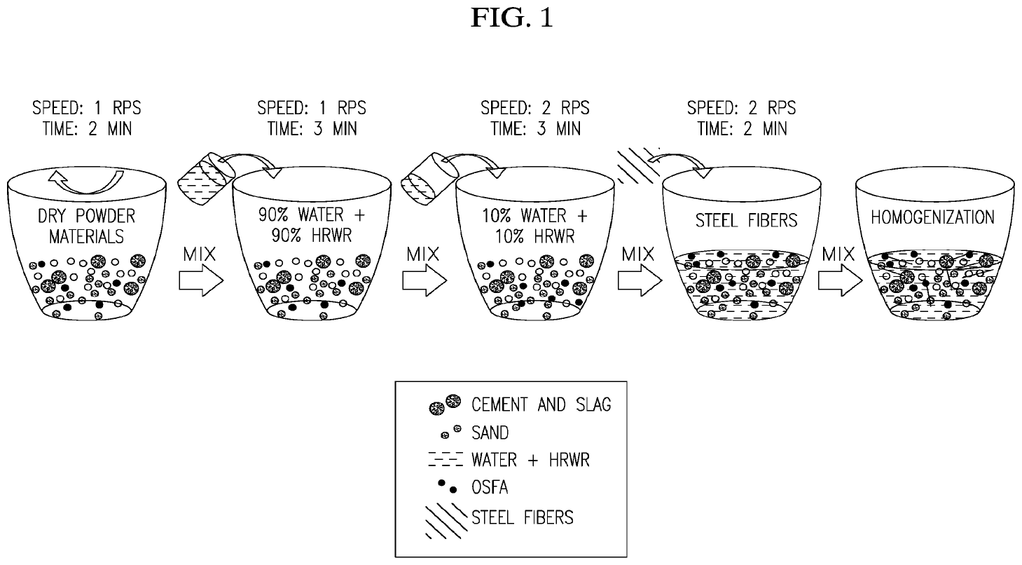

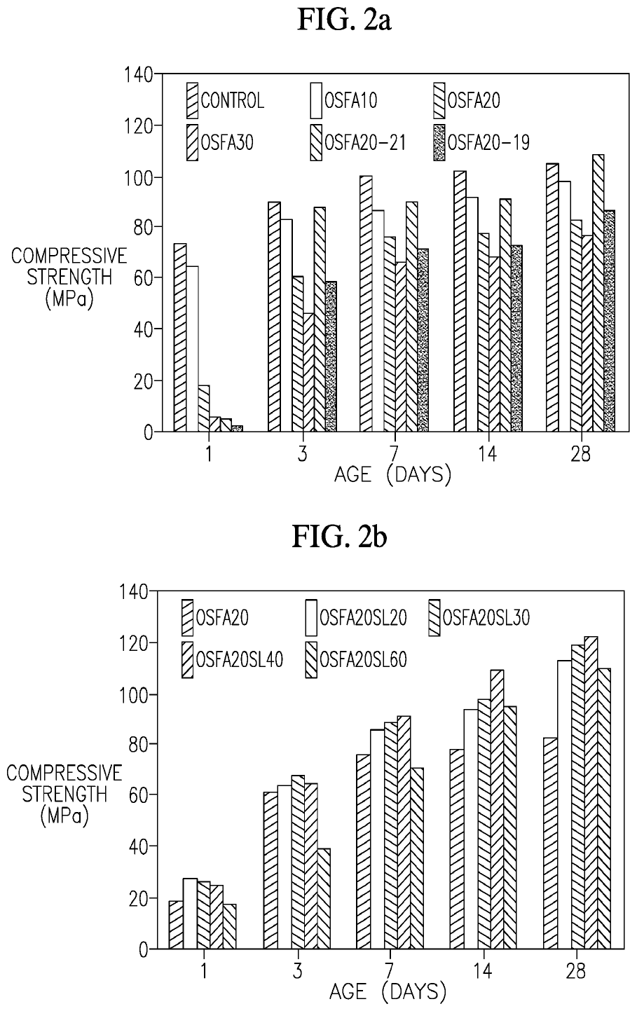

FIGS. 2a-2b plot the results of compressive strengths of the mixtures from 1 day to 28 days. The columns represent the average results of three specimens. The error bars show the standard deviations. FIG. 2a shows the effects of OSFA content and water-to-binder ratio on the compressive strength. FIG. 2b shows the effect of slag content on the compressive strength.

In FIG. 2a, as the OSFA content increased from 0 to 30% by volume of binder, the compressive strength at 1 day was reduced from 73.4 MPa to 5.2 MPa (by 93%), and the compressive strength at 28 days was reduced from 104.7 MPa to 77.1 MPa (by 26%), meaning that addition of OSFA reduced compressive strengths, especially at early ages. It is speculated that the OSFA has a low reactivity in hydration. The speculation is tested by the measurement of hydration heat using the isothermal calorimeter. The results are elaborated in the Hydration Heat section hereinbelow.

As the water-to-binder ratio decreased from 0.23 (OSFA20) to 0.19 (OSFA20-19), the compressive strength at 1 day was reduced from 18.0 MPa to 2.8 MPa (by 84%). The reduction of compressive strength is attributed to the increase of HRWR content (Table 1), because HRWR retards hydration reactions at early ages. This explanation is corroborated by the measurement of hydration heat. The compressive strength of OSFA20-21 was the highest among the three mixtures at 28 days. The compressive strength of OSFA20-21 was higher than that of OSFA20, because the water-to-binder ratio of OSFA20-21 was lower than that of OSFA20. A low water-to-binder ratio tends to densify the microstructure and thus increase the compressive strength. The compressive strength of OSFA20-21 was higher than that of OSFA20-19. This is attributed to the higher HRWR content of OSFA20-19. In summary, the compressive strength is a result of the competition effects of the HRWR content and water-to-binder ratio on the hydration reactions and microstructures.

In FIG. 2b, as the slag content increased from 20% to 60%, the highest compressive strength was achieved by different mixtures at different ages: OSFA20SL20 achieved the highest strength at 1 day; OSFA20SL30 achieved the highest strength at 3 days; and OSFA20SL40 achieved the highest strength at 7 days to 28 days. The results indicate that proper use of slag can increase the compressive strength and show a trend that the optimal slag content increases with the age of mixture. It is speculated that the slag can promote the hydration and pozzolanic reactions but use of an excessive amount of slag can compromise the hydration reactions and microstructure. Since pozzolanic reactions are slower than hydration reactions in general, a higher increase of compressive strength is expected to occur at later ages, consistent with the test results in FIG. 2b. It should be noted that mixture OSFA20SL40 achieved a compressive strength of 121.5 MPa at 28 days. The speculation of the underlying mechanism is further investigated through measurement of hydration heat, XRD test, and TGA test.

### Flexural Properties

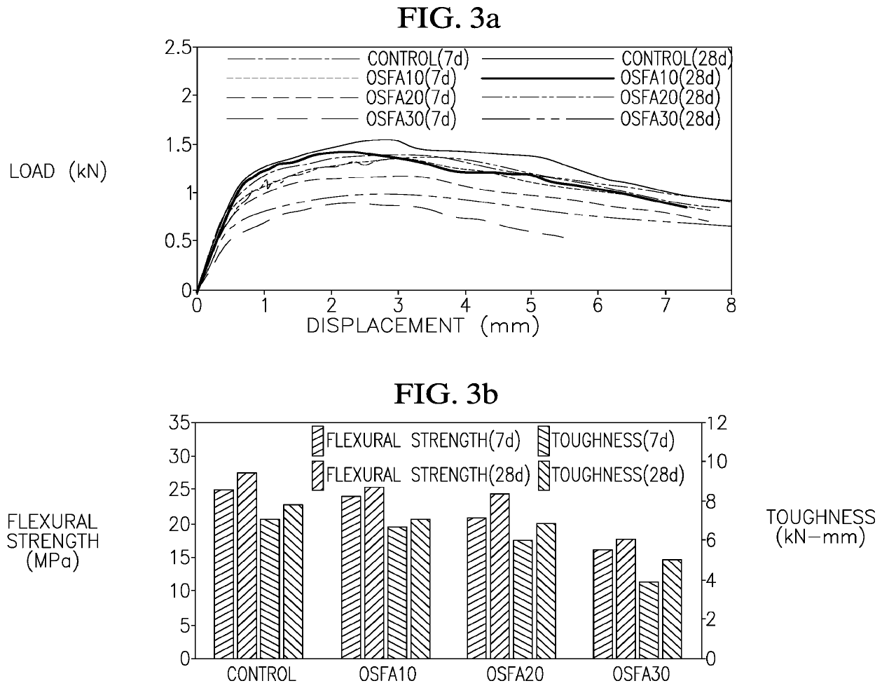

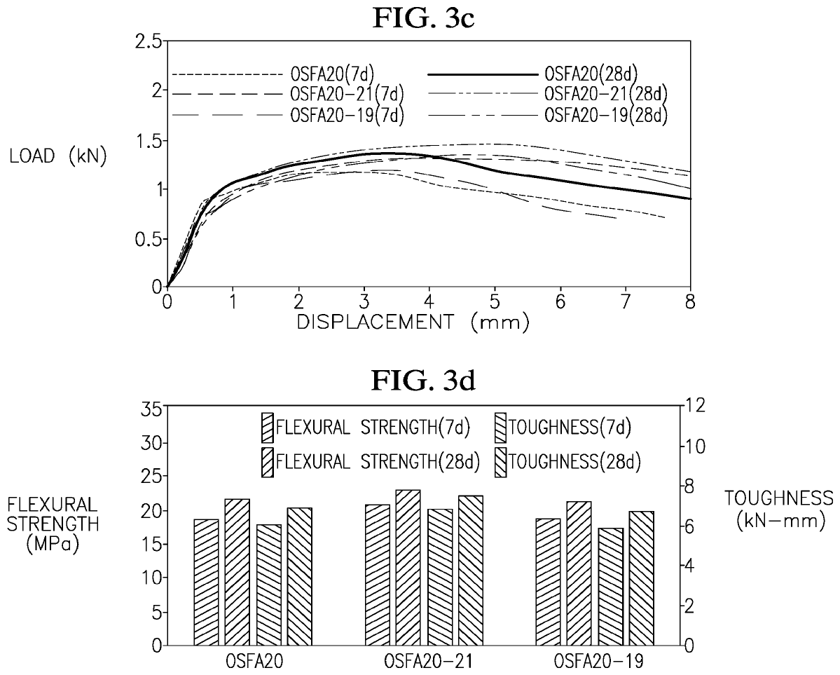

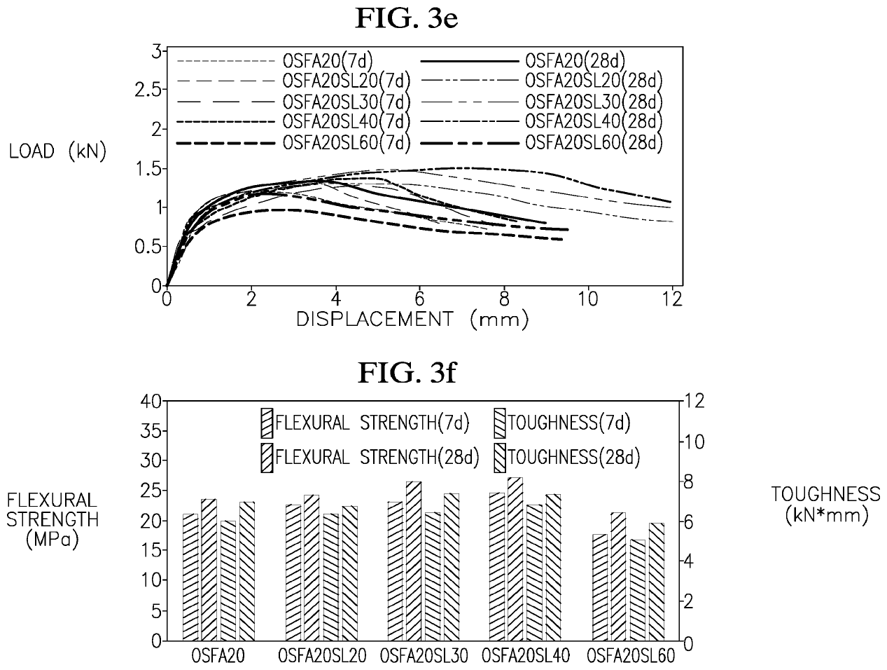

FIGS. 3a-3f plot the flexural test results at 7 days and 28 days. All of the investigated mixtures demonstrated desired ductility. The beams resisted higher loads after they were cracked. FIG. 3a and FIG. 3b show the effect of OSFA content. FIG. 3c and FIG. 3d show the effect of water-to-binder ratio. FIG. 3e and FIG. 3f show the effect of slag content. For each case, tests of three specimens were duplicated, and their results were averaged. The representative load-deflection curves are plotted in FIG. 3a, FIG. 3c, and FIG. 3e. The average results of flexural strengths and standard deviations are plotted in FIG. 3b, FIG. 3d, and FIG. 3f.

As the OSFA content increased from 0 to 30%, the flexural strength was reduced from 24.9 MPa to 16.0 MPa (by 35%) at 7 days and from 27.5 MPa to 17.6 MPa (by 36%) at 28 days. The toughness was reduced from 7.1 kN·mm to 3.9 kN·mm (by 45%) at 7 days and from 7.8 kN·mm to 5.0 kN·mm (by 38%) at 28 days. As the water-to-binder ratio decreased from 0.23 to 0.19, the highest flexural strength and toughness were achieved by mixture OSFA20-21 with a water-to-binder ratio of 0.21. At 28 days, the flexural strength of OSFA20-21 was 7% higher than that of OSFA20 and 8% higher than that of OSFA20-19; and the toughness of OSFA20-21 was 13% higher than that of OSFA20 and 15% higher than that of OSFA20-19.

As the slag content increased from 20% to 60%, the highest flexural strength and toughness were achieved by mixture OSFA20SL40 with a slag content of 40%. At 28 days, the flexural strength of OSFA20SL40 was 11% higher than that of OSFA20 and 27% higher than that of OSFA20SL60; and the toughness of OSFA20SL40 was 6% higher than that of OSFA20 and 26% higher than that of OSFA20SL60. The change trends of flexural strength and toughness are consistent with the trends of compressive strength of the mixtures at 28 days.

### Autogenous Shrinkage

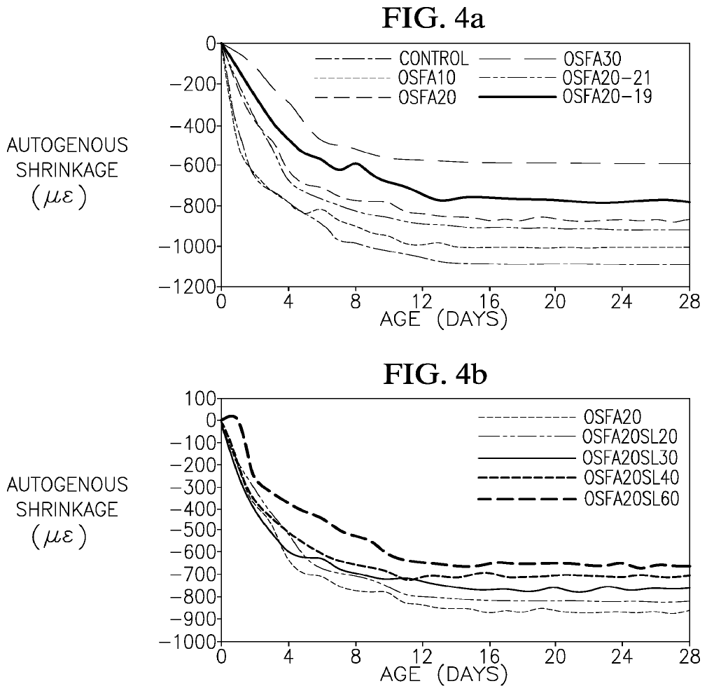

FIGS. 4a-4b plot the results of autogenous shrinkage of the investigated mixtures. FIG. 4a shows the effects of OSFA content and water-to-binder ratio on autogenous shrinkage. FIG. 4b shows the effect of slag content on autogenous shrinkage.

As the OSFA content increased from 0 to 30%, the autogenous shrinkage at 28 days was reduced from 1089με to 593με (by 46%). The reduction of autogenous shrinkage can be attributed to the low reactivity of OSFA as speculated in the Compressive Strength section above. As the water-to-binder ratio decreased from 0.23 to 0.19, OSFA20-21 achieved the highest autogenous shrinkage at 28 days. The autogenous shrinkage of OSFA20-21 was 7% higher than that of OSFA20 and 19% higher than that of OSFA20-19. In general, a low water-to-binder ratio leads to high autogenous shrinkage. However, an excessive amount of HRWR in OSFA20-19 could highly hinder the hydration reactions and thus reduce autogenous shrinkage. As the slag content increased from 0 to 60%, autogenous shrinkage at 28 d was reduced from 859 c to 662με (by 23%). The reduction of autogenous shrinkage is because the slag is less reactive compared with the cement in terms of hydraulic reactions at the early ages.

### Hydration Heat

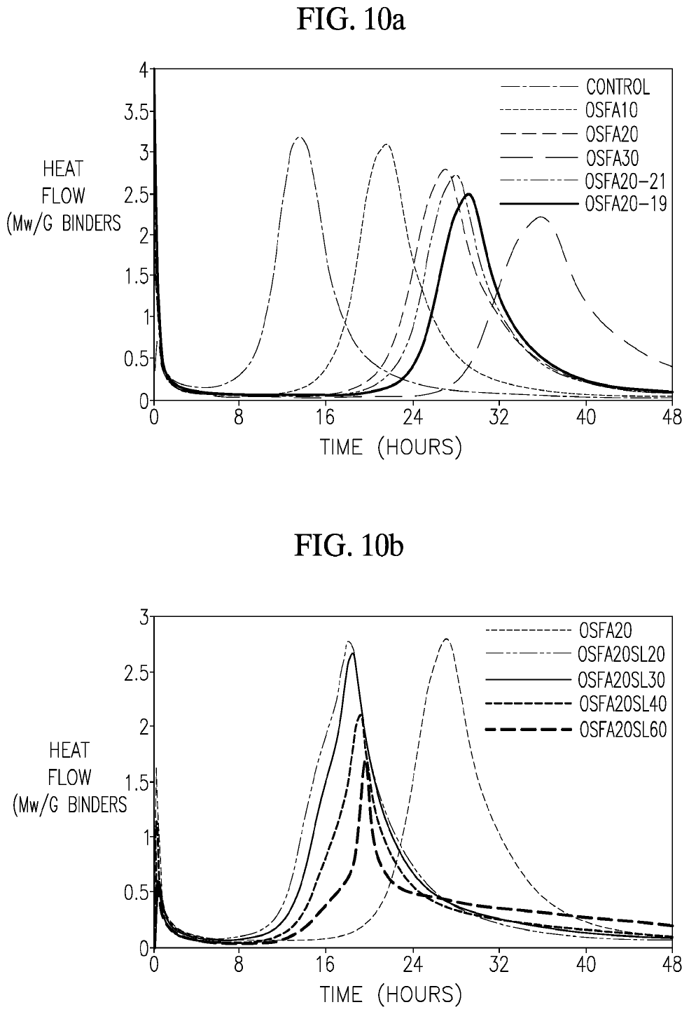

The isothermal calorimetry results were shown in FIGS. 10a-10b. FIG. 10a shows the effects of OSFA content and water-to-binder ratio on hydration kinetics. As the OSFA content increased from 0 to 30%, the dormant period was extended from 7 h to 25 h, and the peak of heat flow was reduced from 3.1 mW/g to 2.2 mW/g, indicating that the OSFA retarded hydraulic reactions. As the water-to-binder ratio decreased from 0.23 to 0.19, the dormant period was increased from 17 h to 21 h, and the peak of heat flow was reduced from 2.7 mW/g to 2.4 mW/g. The reduction of peak heat flow is attributed to the increase of HRWR content, which covers cement particles and retards hydration. FIG. 10b shows the effect of the slag content on the hydration kinetics. As the slag content increased from 0 to 20%, the dormant period decreased from 17 h to 9 h, and the peak heat flow was reduced from 2.7 mW/g to 2.6 mW/g. The acceleration of hydration is attributed to the reduced HRWR content (by 23%), and the reduced peak is due to the reduced cement content. As the slag content increased from 20% to 60%, the hydration reactions were hindered due to reduction of cement content. These results validated the speculations in the Compressive Strength Section.

### Thermogravimetry Analysis

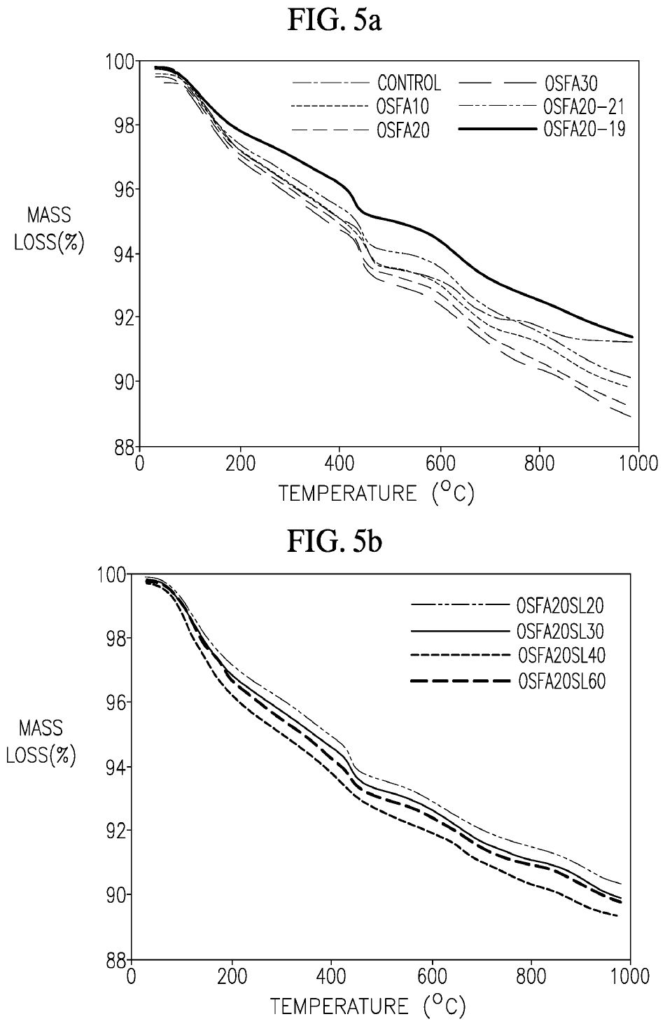

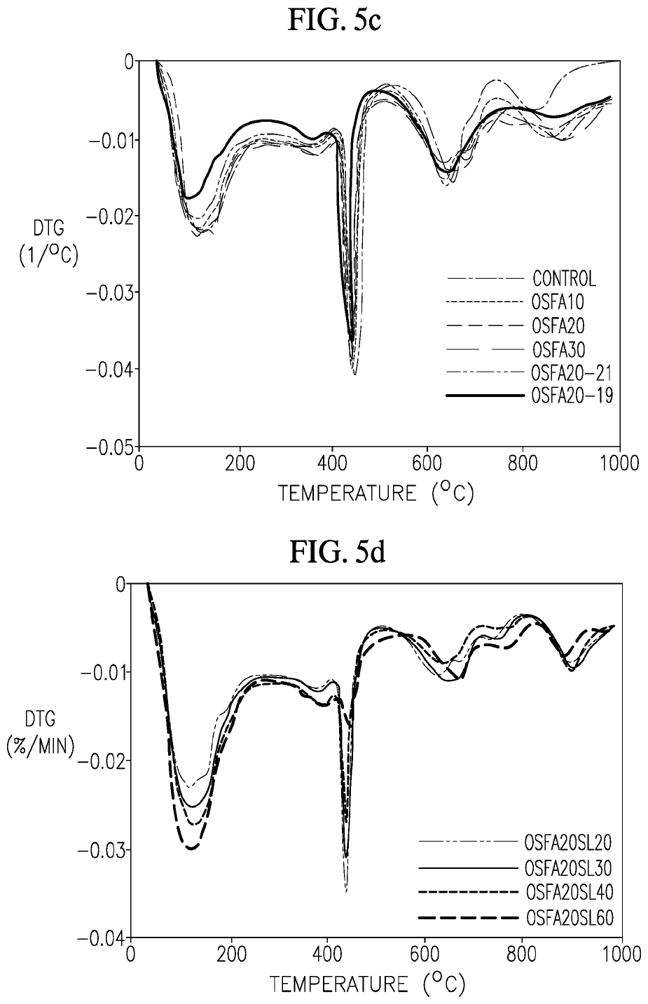

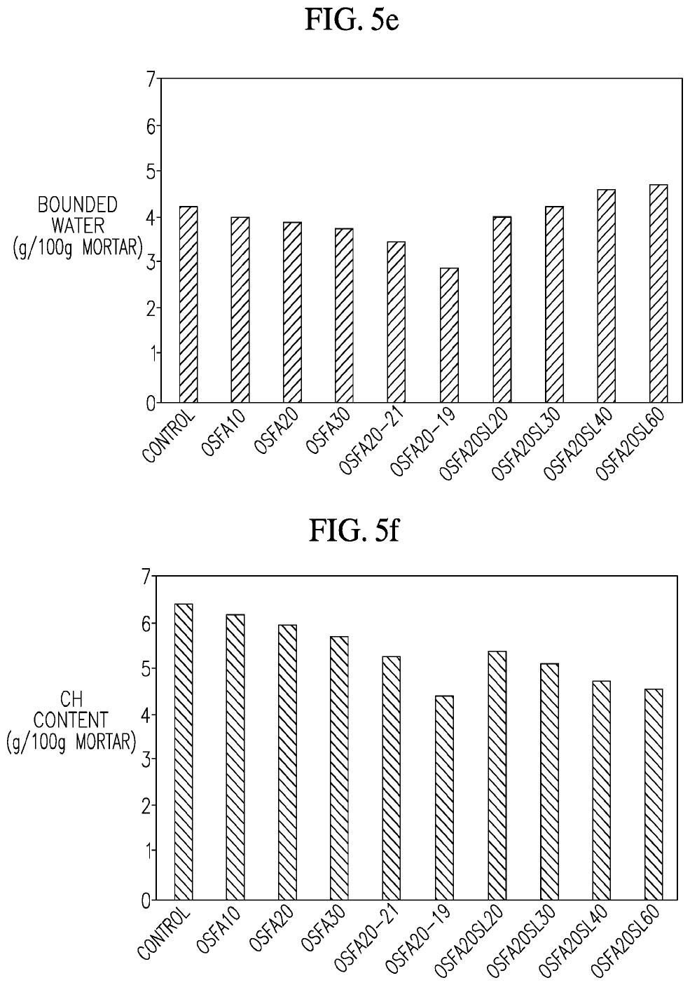

FIGS. 5a-5f show the results of TGA tests using specimens cured for 28 days. FIG. 5a shows the effects of OSFA content and water-to-binder ratio on mass loss. FIG. 5b shows the effect of slag content on mass loss. FIG. 5c shows the effects of OSFA content and water-to-binder ratio on mass loss rate. FIG. 5d shows the effect of slag content on mass loss rate. FIG. 5e shows the bounded water content. FIG. 5f shows the content of calcium hydroxide (CH).

The mass loss rate is represented by derivative thermogravimetry (DTG), which is the derivative of mass loss relating to temperature change. Each DTG curve showed three major peaks, respectively corresponding to: (1) the dehydration of calcium silicate hydrates (C-S-H), ettringite, and AFm phases, up to 400° C.; (2) the dehydroxylation of CH, from 400° C. to 500° C.; and (3) the decarbonation of calcium carbonate, from 500° C. to 800° C.

As the OSFA content increased from 0 to 30%, the bounded water and CH contents normalized per 100-gram mortar were reduced by 12% and 9.5%, respectively, indicating that less hydration products such as C-S-H and CH were produced. Such results are consistent with the results of hydration heat and mechanical properties such as compressive strength and flexural properties. The results further validate the speculations in the Compressive Strength section.

### X-Ray Diffraction

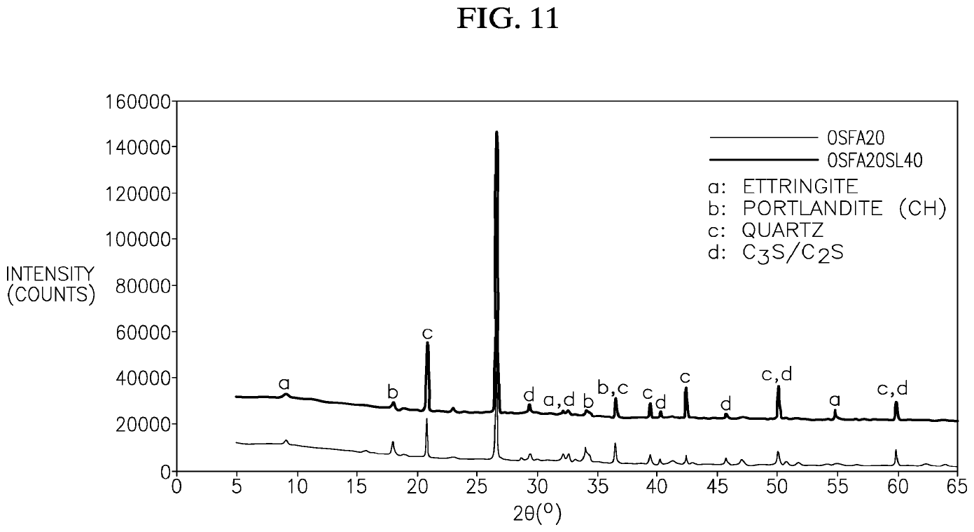

The XRD test results of mixtures OSFA20 and OSFA20SL40 are shown in FIG. 11. The crystal phases of mixtures mainly included quartz, CH, ettringite, and unhydrated cement clinkers. The characteristic peaks of ettringite include 2θ=9.8°, 32.5°, and 54.8°. The characteristic peaks of CH include 2θ=18.0°, 34.10, and 36.5°. The characteristic peaks of quartz include 2θ=21.10, 26.6°, 36.5°, 39.7°, 50.4°, and 60.1°. The characteristic peaks of unhydrated cement clinkers include 2θ=29.5°, 41.2°, 51.3°, and 60.2°. As the slag content increased from 0 to 40%, the mixture OSFA20SL40 showed a lower intensity at 20=18.0°, 34.10, and 36.5°, which correspond to CH, indicating that the addition of slag promoted pozzolanic reaction that consumed CH and produced C-S-H. Such results are consistent with the results of TGA, thus further validating the speculations in the Compressive Strength section.

As the water-to-binder ratio decreased from 0.23 to 0.19, the bounded water and CH contents were reduced by 25% and 24%, respectively. This is attributed to the reduced hydration degree because the water content 0.23 is insufficient to consume the cementitious materials in the mixture. As the slag content increased from 20% to 60%, the bounded water content was increased by 21%, while the CH content was reduced by 15% This was because the slag had amorphous silica that could react with CH and produce calcium silicate hydrates through pozzolanic reactions.

### Leaching of Heavy Metals

The results of the leaching tests are listed in Table B3 below. The concentrations of As, Pb, and Se leached from the OSFA and crushed UHPC are lower than the allowable upper limits, indicating the leaching resistance of the UHPC mixtures satisfies requirements. The concentrations of the heavy metals of UHPC mixtures are lower than those of OSFA powder, meaning that the UHPC mixtures helps immobilize the heavy metals.

TABLE B3
Results of TCLP

| Heavy metals | As | | Pb | | Se | |
|---|---|---|---|---|---|---|
| OSFA powder | 0.78 | ppm | <0.1 | ppm | 0.22 | ppm |
| OSFA20 | <0.1 | ppm | <0.1 | ppm | <0.1 | ppm |
| OSFA20-21 | <0.1 | ppm | <0.1 | ppm | <0.1 | ppm |
| OSFA20SL40 | <0.1 | ppm | <0.1 | ppm | <0.1 | ppm |
| OSFA20SL60 | <0.1 | ppm | <0.1 | ppm | <0.1 | ppm |
| Allowable limitations | 5 | ppm | 5 | ppm | 1 | ppm |

### Carbon Footprint

With the inventory data in Table B4, the carbon footprint of each mixture can be calculated using Eq. (2):

$$C = {\sum }_{i = 1}^{n} {c}_{i} {r}_{i} \qquad ( 2 )$$

where C is the carbon footprint of a mixture; cᵢ is the unit carbon emission of the i-th ingredient of the mixture (i=1, 2, 3, . . . , n, and n=7), as listed in Table B4; and rᵢ is the S mass of the i-th ingredient of the mixture, as listed in Table 1.

TABLE B4
Inventory of unit cost, carbon footprint,
and embodied energy of raw materials

| | | | Carbon emission | Embodied energy |
|---|---|---|---|---|
| No. | Ingredient | Cost ($/kg) | (kg/kg) | (MJ/kg) |
| 1 | Cement | 0.11 | 0.83 | 4.73 |
| 2 | OSFA | 0.00 | 0.00 | 0.00 |
| 3 | Slag | 0.10 | 0.02 | 1.59 |
| 4 | Sand | 0.02 | 0.01 | 0.11 |
| 5 | HRWR | 3.60 | 0.72 | 18.30 |
| 6 | Water | 0.00 | 0.00 | 0.01 |
| 7 | Steel fiber | 4.76 | 1.49 | 20.56 |

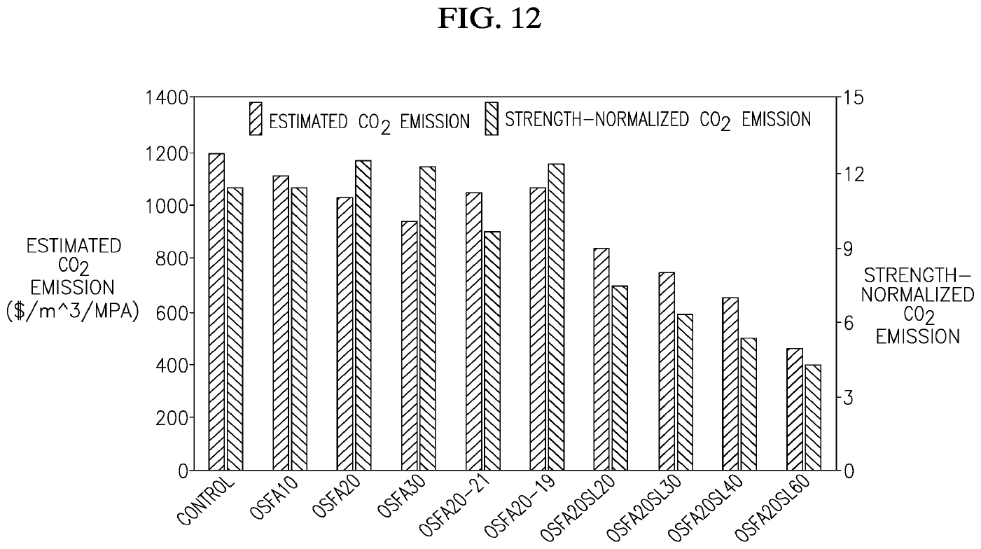

According to Eq. (2), the unit carbon footprint of each mixture was calculated. With the compressive strength (MPa) of each mixture at 28 days, the strength-normalized carbon footprint (kg/m³/MPa) was calculated. FIG. 12 plots the results of the unit carbon footprint and strength-normalized carbon footprint of the investigated mixtures. As the OSFA content increased from 0 to 30%, the unit carbon footprint was reduced from 1194 to 942 kg/m³, and the strength-normalized carbon footprint was increased from 11.4 kg/m³/MPa to 12.2 kg/m³/MPa, because the use of OSFA reduced the compressive strength. As the water-to-binder ratio decreased from 0.23 to 0.19, the unit carbon footprint was increased from 1028 kg/m³ to 1068 kg/m³, while the strength-normalized carbon footprint was first reduced and then increased. OSFA20-21 achieved the lowest strength-normalized carbon footprint, because OSFA20-21 had a high compressive strength. As the slag content increased from 0 to 60%, the unit carbon footprint was reduced from 1028 kg/m³ to 460 kg/m³, and the strength-normalized carbon footprint was reduced from 12.5 kg/m³/MPa to 4.2 kg/m³/MPa. Compared with the control mixture, the use of OSFA and slag reduced the unit carbon footprint, and combination use of OSFA, and slag reduced both the unit carbon footprint and strength-normalized carbon footprint. For the optimal UHPC mixture is OSFA20SL40, the unit carbon footprint and strength-normalized carbon footprint are 687 kg/m³ and 5.4 kg/m³/MPa, respectively.

### Embodied Energy

With the inventory data in Table B4, the embodied energy of each mixture can be calculated using Eq. (3):

$$E = {\sum }_{i = 1}^{n} {e}_{i} {r}_{i} \qquad ( 3 )$$

where E is the embodied energy of a mixture; eᵢ is the unit embodied energy of the i-th ingredient of the mixture (i=1, 2, 3, . . . , n, and n=7), as listed in Table B4; and rᵢ is the mass of the i-th ingredient of the mixture, as listed in Table 1.

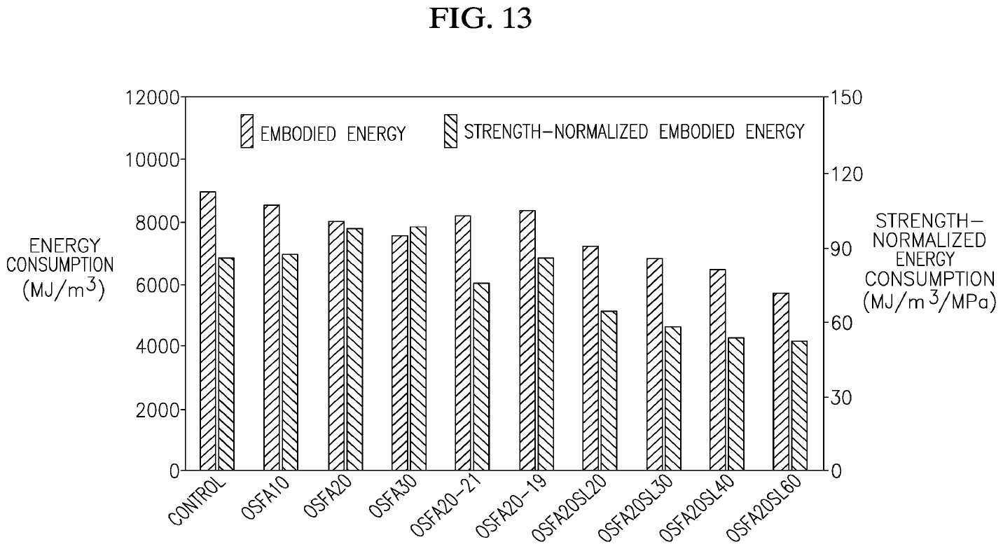

According to Eq. (3), the unit embodied energy of each mixture was calculated. With the compressive strength (MPa) of each mixture at 28 days, the strength-normalized embodied energy (MJ/m³/MPa) was calculated. FIG. 13 plots the results of embodied energy and strength-normalized embodied energy of the investigated mixtures. As the OSFA content increased from 0 to 30%, the embodied energy was reduced from 8983 MJ/m³ to 7532 MJ/m³, and the strength-normalized embodied energy was increased from 85.7 MJ/m³/MPa to 97.8 MJ/m³/MPa, because the use of OSFA reduced the compressive strength. As the water-to-binder ratio decreased from 0.23 to 0.19, the embodied energy was increased from 8029 MJ/m³ to 8356 MJ/m³, while the strength-normalized embodied energy was first reduced and then increased. OSFA20-21 achieved the lowest strength-normalized embodied energy, because OSFA20-21 had a high compressive strength. As the slag content increased from 0 to 60%, the embodied energy was reduced from 8029 MJ/m³ to 5696 MJ/m³, and the strength-normalized embodied energy was reduced from 97.5 MJ/m³/MPa to 52.2 MJ/m³/MPa. Compared with the control mixture, the use of OSFA and slag reduced the embodied energy, and the combination use of OSFA, and slag reduced both the embodied energy and strength-normalized embodied energy. The optimal UHPC mixture in this scenario is OSFA20SL40. The embodied energy and strength-normalized embodied energy are 6471 MJ/m³ and 53.3 MJ/m³/MPa, respectively.

Comparison with Other UHPC Mixtures

In recent years, development of UHPC mixtures mainly focused on reducing the material cost, CO₂ emission, and embodied energy without mitigating the mechanical properties. In general, UHPC mixtures with higher mechanical performance have higher material cost, CO₂ emission, and embodied energy. The UHPC mixture developed in this study shows the best performance.

### Example 2

### Raw Materials

The present example adopted Type I Portland cement, OSFA from a power plant, silica sand, polyvinyl alcohol (PVA) fibers, chemical admixtures, and tap water. The cement and OSFA were used as the binders. Silica sand was used as the fine aggregate. A polycarboxylate-based high-range water reducer (HRWR) was used to improve the flowability. PVA fibers measuring 12 mm in length were used as a tension reinforcement to enhance the crack resistance. Tap water was used as the mixing water. The chemical compositions of the Type I Portland cement and OSFA ash were characterized by X-ray fluorescence (XRF) and XRD, as listed in Table S1. The particle size distribution of the cement, OSFA, and sand are presented in FIG. 6b.

TABLE S1
Chemical and physical properties of raw materials

| | Type I cement | OSFA | Sand |
|---|---|---|---|
| SiO₂ (%) | 22.44 | 14.84 | 86.50 |
| Al₂O₃ (%) | 2.76 | 9.04 | 0.39 |
| Fe₂O₃ (%) | 2.24 | 5.98 | 1.47 |
| CaO (%) | 68.05 | 2.13 | 9.42 |
| MgO (%) | 0.91 | 0.80 | — |
| SO₃ (%) | 2.25 | 3.42 | — |
| Na₂O (%) | 0.19 | 0.22 | — |
| K₂O (%) | 0.11 | 1.10 | — |
| TiO₂ (%) | 0.14 | 0.44 | — |
| P₂O₅ (%) | 0.09 | 0.27 | — |
| Mn₂O₃ (%) | 0.03 | 0.01 | — |
| SrO (%) | — | 0.03 | — |
| C₃S (%) | 62.35 | — | — |
| C₂S (%) | 20.28 | — | — |
| C₃A (%) | 1.42 | — | — |
| C₄AF (%) | 5.83 | — | — |
| LOI (%) | 1.28 | 49.80 | 0.24 |
| Specific gravity, SSD | 3.15 | 1.45 | 2.64 |

The morphology of the OSFA particle was characterized through scanning electronic microscopy (SEM). FIG. 6a shows a SEM picture of the OSFA. The OSFA has a combination of irregular needles, platelets, and a limited proportion of spherical particles. The morphology of the OSFA is different from the morphology of Class C and Class F fly ash that mainly have spherical particles. The particle size distribution of the cement, OSFA, and sand are characterized using a laser diffraction particle size analyzer (model: Horiba LA-960). The particle size distribution curves are presented in FIG. 6b. The size of OSFA is significantly lower than that of the cement, with a mean particle size about 50% that of the cement.

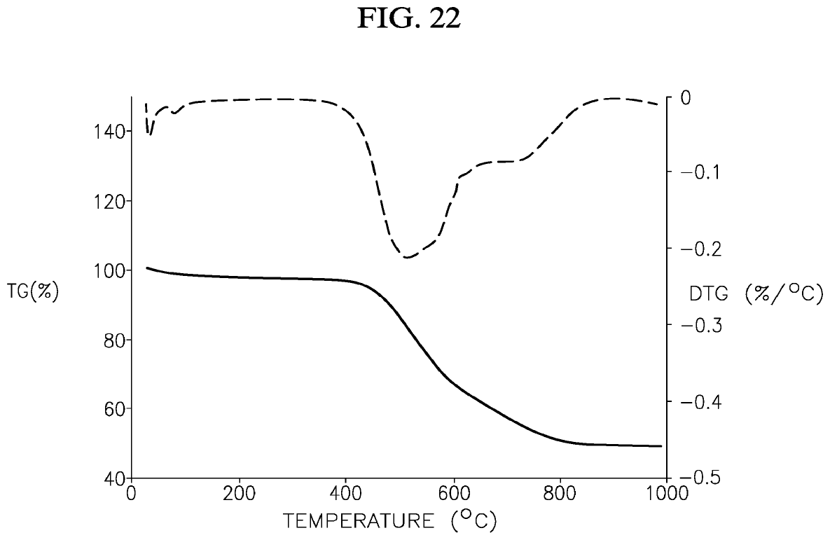

The LOI of the OSFA was evaluated using a thermogravimetric analyzer (TGA, model: TA® TG55) with an air flow at a constant rate of 50 ml/min. FIG. 22 shows the result of the TGA test. The mass loss of the OSFA reached 49.8% as the temperature increased from 20° C. to 1000° C. at a constant temperature increasing rate (20° C./min). It was speculated that the mass loss was mainly attributed to elemental carbon in the OSFA. To verify this speculation, a combustion test using a carbon analyzer (model: Perkin-Elmer 2400) was conducted to quantify the carbon content. It was found that elemental carbon accounted for 41.8% of the mass of OSFA, which is 84% of the LOI of the OSFA. The remaining 16% of LOI can be attributed to partial decomposition of gypsum in the OSFA heated at elevated temperatures. The mineral composition of the OSFA was characterized using a XRD instrument (model: Panalytical X' pert Pro). The readings were taken in vertical Bragg-Brentano (0-6) geometry between 5° and 70° with a step size of 0.03° at one step per second. The X-ray tube generator was operated at 30 kV and 10 mA. FIG. 8b shows the XRD result of the OSFA. The main minerals of the OSFA are gypsum, quartz, and hematite, which account for 11.6%, 29.6%, and 11.9% of the total mineral composition, respectively.

### Mixture Design

The OSFA was used to partially replace the cement. Mixture M1 was the control mixture. Mixtures M2, M3, and M4 that had OSFA contents of 20%, 40% and 60% by volume of binder were used to investigate the effect of OSFA content. Mixtures M5 and M6 were used to investigate the effect of fiber contents (1% to 2%). Mixtures M7 and M8 were used to investigate the effect of w/b (0.22 to 0.30). Mixtures M9 and M10 were used to investigate the effect of s/b (0.32 to 0.40). The detailed mix proportions are presented in Table S2.

TABLE S2
Mix designations and proportions of SHCC mixtures (kg/m³)

| | | | Silica | | | PVA | |
|---|---|---|---|---|---|---|---|
| Designation | Cement | OSFA | sand | Water | HRWR | fiber | Note |
| M1 | 1346 | 0 | 485 | 350 | 13 | 26 | Control |
| M2 | 1149 | 132 | 461 | 333 | 13 | 26 | OSFA |
| M3 | 921 | 283 | 434 | 313 | 12 | 26 | content |
| M4 | 660 | 456 | 402 | 290 | 11 | 26 | |
| M5 | 1149 | 132 | 461 | 333 | 13 | 13 | Fiber |
| M6 | 1149 | 132 | 461 | 333 | 13 | 20 | content |
| M7 | 1149 | 132 | 461 | 282 | 13 | 26 | w/b |
| M8 | 1149 | 132 | 461 | 384 | 13 | 26 | |
| M9 | 1149 | 132 | 410 | 333 | 13 | 26 | s/b |
| M10 | 1149 | 132 | 513 | 333 | 13 | 26 | |

### Specimen Preparation

A mortar mixer (capacity: 5 L) was used to mix materials in this example. In the mixing, first of all, the dry ingredients (cement, OSFA, and sand) were added to the mixer and mixed for 3 min. After the dry ingredients were uniform, the high-range water reducer premixed with tap water was added to the mixer and mixed for 3 min. Finally, the fibers were slowly added to the mixer and mixed for another 3 min. After the mixing, the mixture was examined by hand. There should be no fiber agglomeration and no bleeding.

### Test Methods

The mini-slump spread of each SHCC mixture was evaluated in accordance with ASTM C230/C230M (ASTM, 2021). The rheological properties of the paste of SHCC mixtures were evaluated using a rheometer (model: Anton Paar MCR 302) with parallel plates.

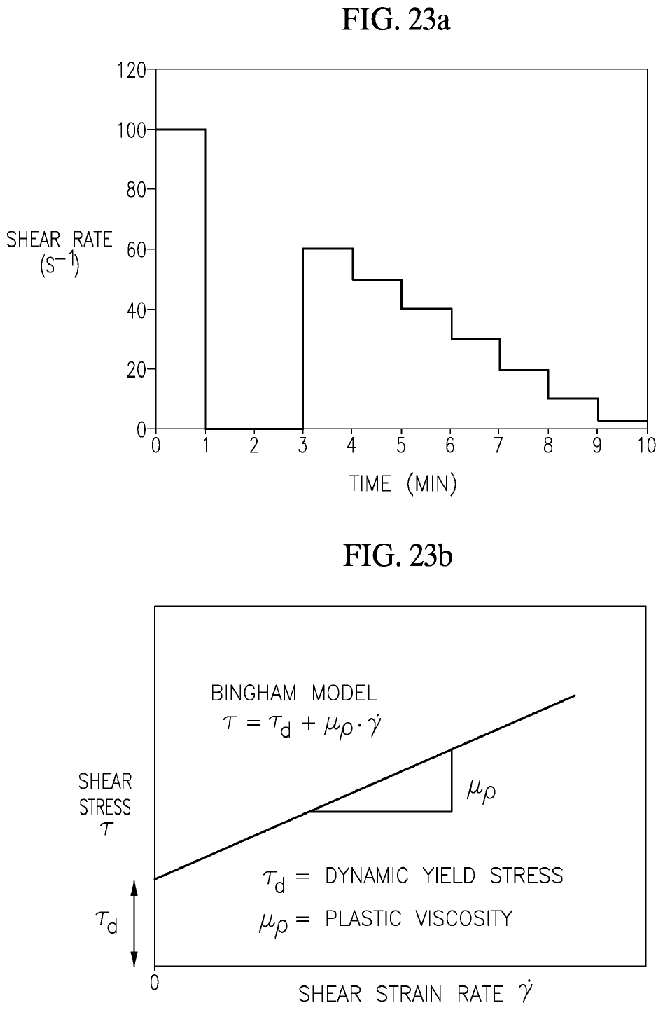

The parallel plates of the rheometer measured 25 mm in diameter and were sandblasted to minimize the slip between the plates and the paste during mixing. Throughout the rheology test, the temperature of the paste was maintained at 25° C. The test was started 5 min after the mixing procedures were completed. To minimize the effect of shear history on the test, a pre-shearing process (100 s-1 for 1 min) and resting process (0 s-1 for 2 min) were applied, so that the tests of all the samples started from the same point. Then, samples were sheared at 60 s-1, 50 s-1, 40 s-1, 30 s-1, 20 s-1, and 10 s-1, respectively, and each shear rate was sustained for 1 min, as shown in FIG. 23a. The plastic viscosity was determined by fitting the equilibrium curve into the Bingham model shown in FIG. 23b. Immediately after mixing, the fresh mixture was used to cast specimens that were used to test the different material properties. The specimens were stored in the laboratory at room temperature (25° C.±2° C.) and normal relatively humidity (50%±5%) for 24 h. Then, the specimens were demolded and cured in air at room temperature (25° C.±2° C.) and normal relatively humidity (50%±5%) until the age of testing.

The hydration heat was measured by an isothermal calorimeter (model: Calmetrix I-Cal 4000 HPC) to evaluate the hydration kinetics. About 60 g of fresh SHCC suspension was sealed in a plastic vial and placed into the calorimeter, which was maintained at 25° C. The heat of hydration was constantly measured from 2 min after completion of mixing to 48 h. The results were normalized by the mass of the binder.

The compressive strength was tested at 7 days and 28 days in accordance with ASTM C109 (ASTM, 2020). A four-point bending test set-up to evaluate the flexural strength and ductility of plate specimens made using the SHCC mixtures at 7 days and 28 days in accordance with JSCE recommendations (Yokota, 2008).

Each of the plates measured 12.7 mm (0.5 in) in thickness, 76.2 mm (3 in) in width, and 304.8 mm (12 in) in length were loaded using a load frame (model: Instron® 5982, load capacity: 10 kN) under displacement control. The displacement rate was 0.05 mm/min. The flexural stress was calculated using Eq. (4):

$$σ = \frac{3 F ( L - {L}_{i} )}{2 {bd}^{2}} \qquad ( 4 )$$

where F, L, Lᵢ, b, and d represent the peak load, distance between supports (L=240 mm), distance between loads (Lᵢ=94 mm), beam width, and beam depth, respectively.

The microstructures of the hardened SHCC mixtures blended with OSFA were characterized through XRD and TGA using the same instruments as those used to characterize the OSFA, as introduced above. The samples of the mixtures were immersed in isopropanol with a concentration of 99% to stop hydration at 28 days.

In the XRD tests, the readings were taken in vertical Bragg-Brentano (θ-θ) geometry in the range of 5° and 700 with 0.03° step size at 1 step per second. The X-ray tube generator was operated at 30 kV and 10 mA. In the TGA test for each mixture, about 50 mg of sample from dried slices was crushed into fine powders and vacuum dried for 24 h before the test. During the test, the sample was heated at a constant rate of 20° C./min from 20° C. to 1000° C. in a nitrogen flow at the flow rate of 50 ml/min.

The leaching of heavy metals from the OSFA and SHCC was evaluated through toxicity characteristic leaching procedure (TCLP). Batch leaching tests were conducted according to the code (EPA, 1992).

The OSFA and mixture M3 were respectively grounded and mixed with extraction solution with a liquid-to-solid ratio of 20. The samples were put in polyethylene bottles tumbled at a speed of 30 rpm for 18 h. Then, the liquid was vacuum filtered through glass fiber filters (0.6 μm to 0.8 μm) and used to measure concentrations of heavy metal ions using inductively coupled plasma—optical emission spectrometry (ICP-OES). Heavy metals arsenic (As), lead (Pb), and selenium (Se) in the OSFA were higher than the allowable limits (Table S3) and thus investigated.

TABLE S3
Heavy metal contents in OSFA and allowable leaching limits

| Heavy metals | As | | Pb | | Se | |
|---|---|---|---|---|---|---|
| OSFA | 518 | ppm | 116 | ppm | 360 | ppm |
| Allowable leaching limits | 5 | ppm | 5 | ppm | 1 | ppm |

### Fresh Properties

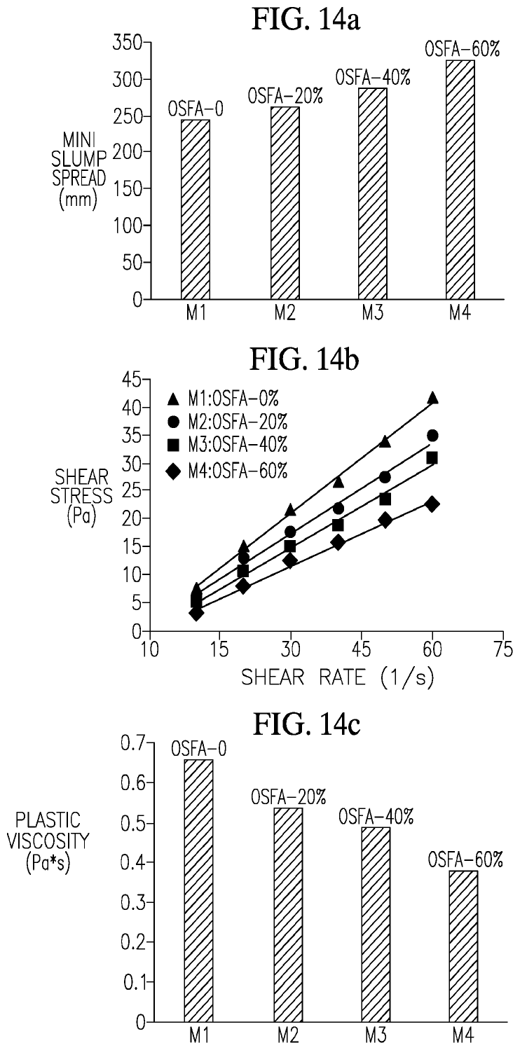

FIGS. 14a-14c presents fresh properties of mixtures M1 to M4 when the HRWR content was fixed at 1%, by mass of binder. FIG. 14a shows the results of mini-slump spread. As the OSFA content increased from 0 to 60%, the mini-slump spread was increased from 244 mm to 325 mm (by 33%). The increase of flowability is associated with the grain size gradation because the OSFA has finer particles, as shown in FIG. 6b. Smaller fly ash particles can fill the interparticle spaces between the cement particles. Therefore, the addition of the fly ash particles can reduce the water volume needed to fill the interparticle gaps, thus improving the flowability.

FIGS. 14b and 14c illustrate the rheological properties of the pastes of mixtures M1 to M4. FIG. 14b shows the equilibrium flow curves fitted into the Bingham model. The values of plastic viscosity can be determined from the fitting lines and plotted in FIG. 14c. As the OSFA content increases from 0 to 60%, the plastic viscosity is decreased from 0.66 MP s to 0.38 MP s (by 42%). The reduction of the plastic viscosity can be attributed to the finer particle size of the OSFA, because the fine particles can fill the interparticle spaces between cement particles and save water volume for filling the spaces. In addition, the increase of packing density helps fill voids in a dynamic condition, which provides additional lubrication to reduce the shear stress. The results of fresh properties of mixtures M6 to M10 are consistent with existing studies on the effects of PVA fiber content, water-to-binder ratio, and sand-to-binder ratio on fresh properties of cementitious materials. The mini-slump spread increases with the decrease of fiber content, binder content, and sand-to-binder ratio.

### Mechanical Properties

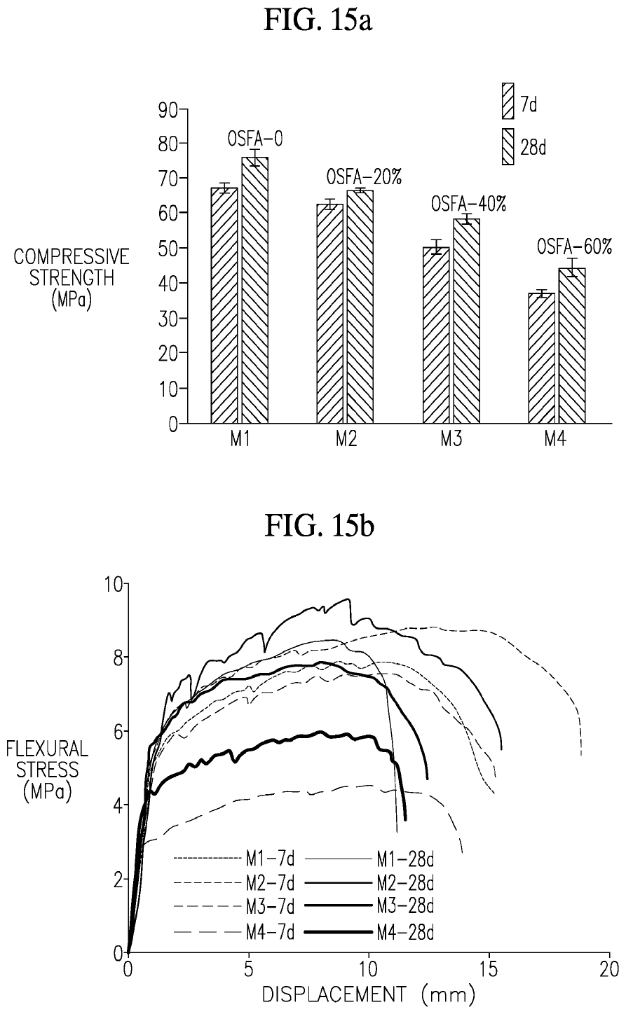

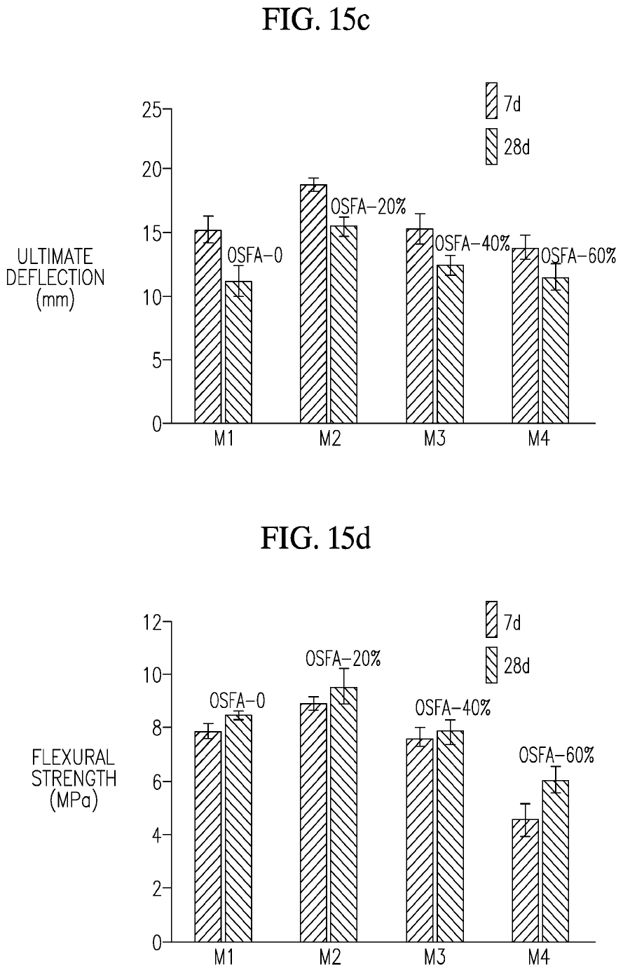

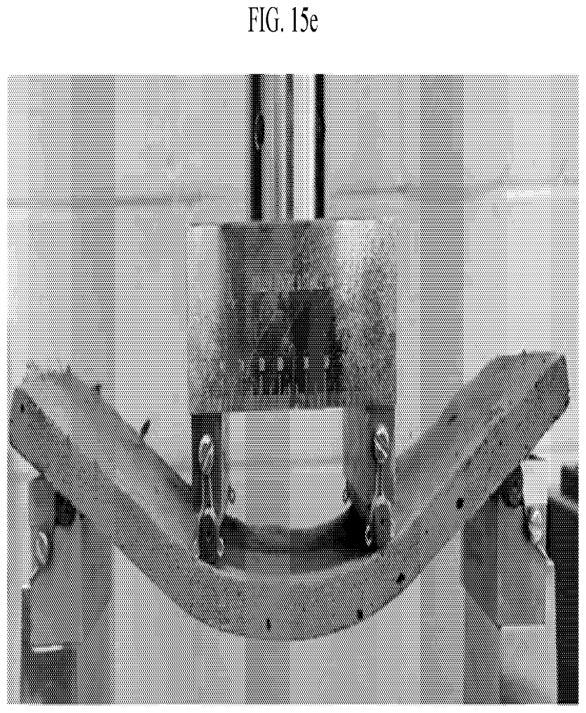

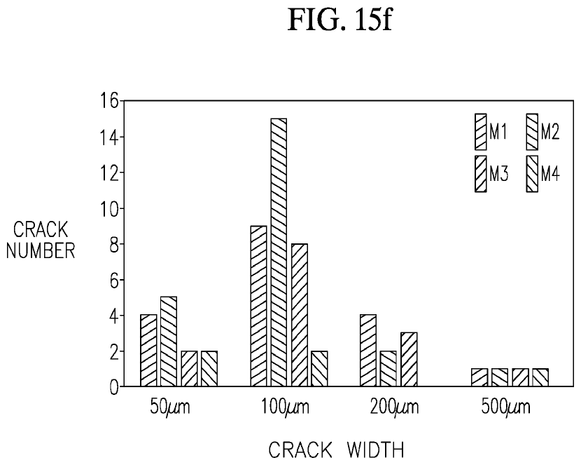

FIGS. 15a-15f show the effects of the OSFA content on the mechanical properties. As is shown in FIG. 15a, as the OSFA content increased from 0 to 60%, the compressive strength at 7 days was reduced from 66.2 MPa to 36.3 MPa (by 45%), and the compressive strength at 28 days was reduced from 75.9 MPa to 44.2 MPa (by 42%). It is speculated that the OSFA has a low reactivity and negative effect on the hydration reactions. The speculation can be tested by the measurement of hydration heat using the isothermal calorimeter as elaborated hereinbelow.

As the OSFA content increased from 0% to 20%, the flexural strength and ductility were increased. As the OSFA content was further increased, the flexural strength and ductility were reduced (seen in FIG. 15b). Specifically, as the OSFA content increased from 0% to 20%, the flexural strength was increased from 8.5 MPa to 9.6 MPa (by 13%), and the deflection corresponding to the peak flexural stress was increased from 11.2 mm to 15.5 mm (by 29%) (shown in FIG. 15c). As the OSFA content increased from 20% to 60%, the flexural strength was reduced to 4.6 MPa, and the deflection corresponding to the peak flexural stress was reduced to 11.5 mm at 28 days (presented in FIG. 15d). It is speculated that the use of 20% OSFA can mechanistically tune matrix, fiber, and fiber-matrix interface to achieve the optimal flexural ductility. A matrix without any OSFA can be too strong to crack before many fibers are ruptured. A matrix with more than 20% OSFA can be too weak in terms of matrix strength and fiber-matrix interface bond, and a weak interface can compromise the bridging effect of fibers.

FIG. 15e shows a plate specimen made using mixture M2 under four-point bending. The plate exhibited a large deformability and sustained load-carrying capability under loading before the specimen failed. The bending moment generated tensile stresses and microcracks at the bottom of the plate. FIG. 15f presents the crack width distributions of specimens after the test. As the OSFA content increased from 0% to 20%, the number of cracks increased significantly, and most cracks had a width between 50 μm and 100 μm, which is narrow and desired for long-term durability. As the OSFA content increased from 20% to 60%, the number of cracks was reduced. The change of crack pattern can be attributed to the reduction of the strength of the matrix.

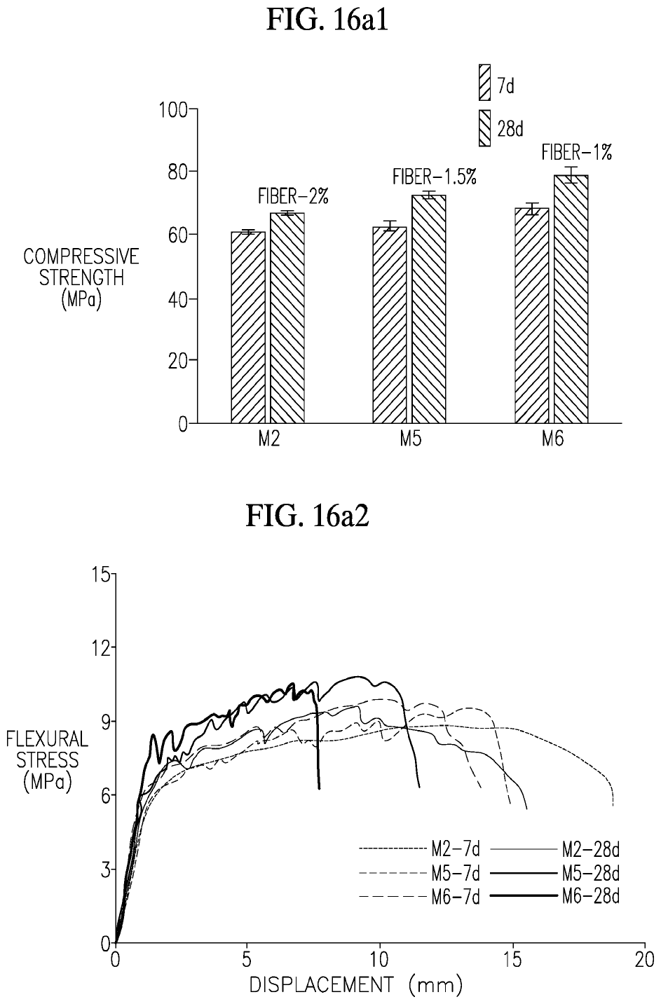

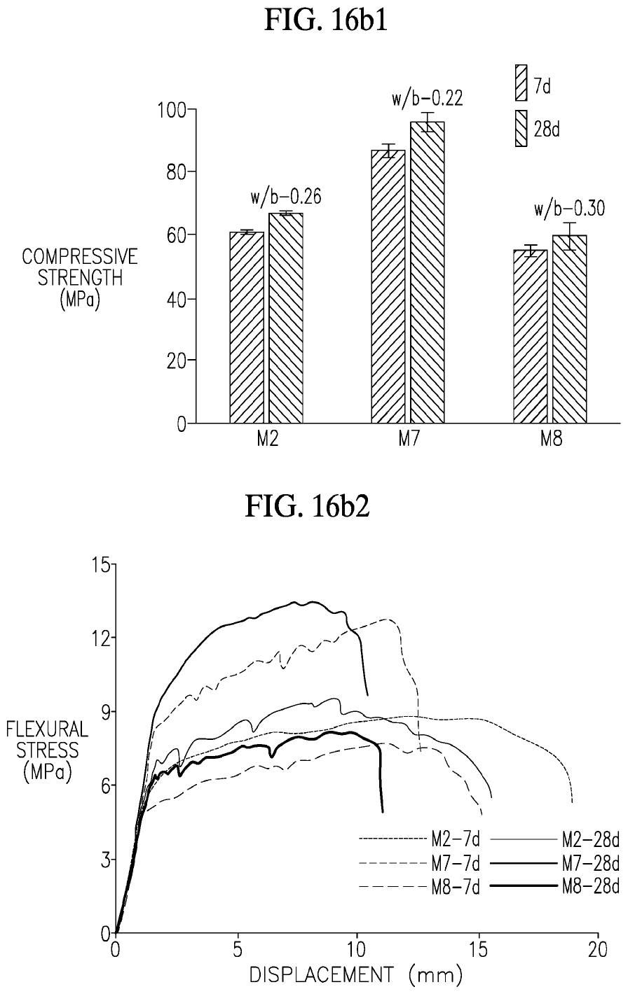

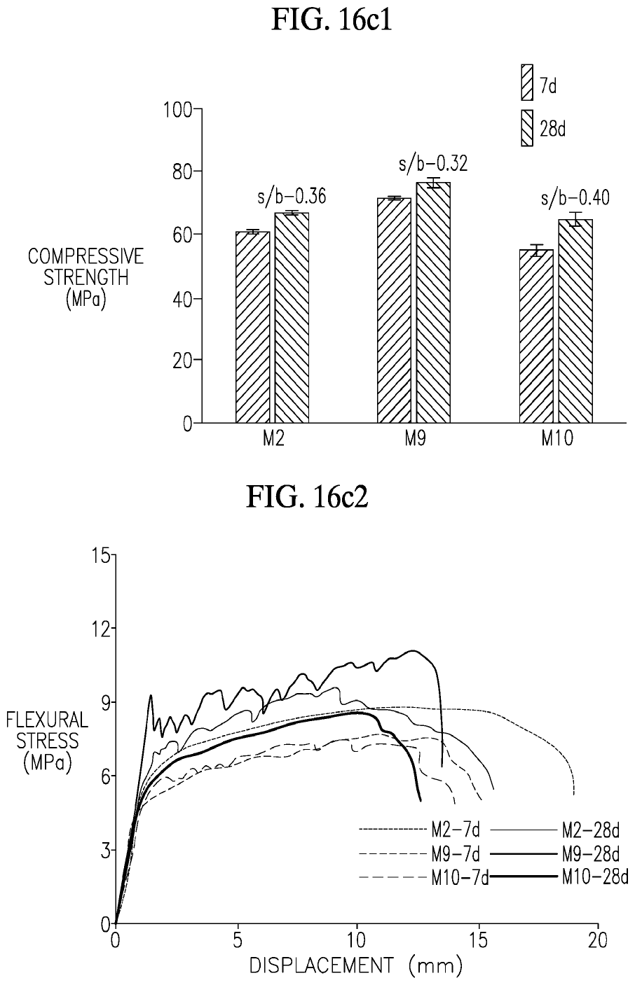

FIGS. 16a1-16c2 show the effects of fiber content, w/b, and s/b on the compressive and flexural properties. As the fiber content decreased from 2% to 1%, the compressive and flexural strengths were increased, but the ductility was reduced, because reduction of fiber reduced defects (e.g., voids) and enhanced the matrix but compromised the fiber bridging effect, consistent with previous research. As w/b decreased from 0.30 to 0.22, the compressive and flexural strengths were increased consistently, as expected, but the ductility was first increased and then reduced. The mixture M2 with a w/b of 0.26 achieved the highest ductility, consistent with previous research. As s/b decreased from 0.40 to 0.32, the compressive and flexural strengths were increased consistently, as expected, but the ductility was first increased and then reduced, similar to the trend of w/b. Mixture M2 with a s/b of 0.36 achieved the highest ductility, consistent with previous research. In summary, compared with mixtures M5 to M10, mixture M2 achieved the best ductility.

### Hydration Heat

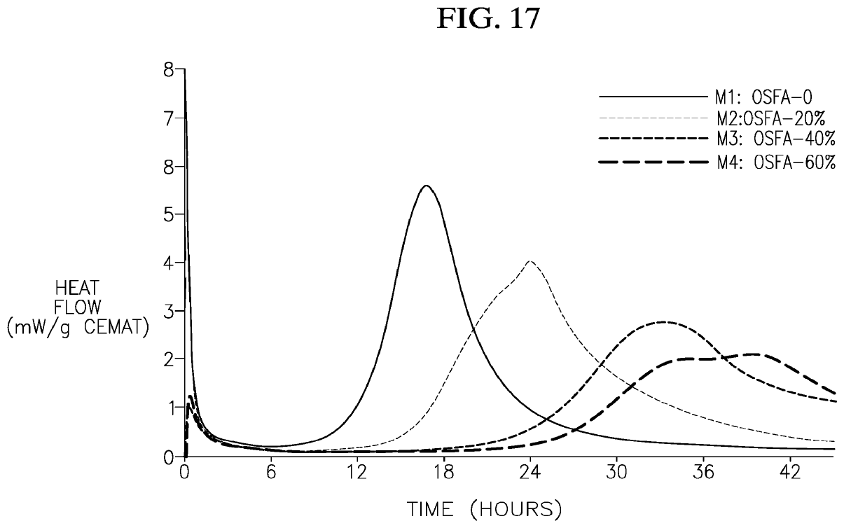

The hydration kinetics of mixtures M1 to M4 are shown in FIG. 17. Compared with the control mixture M1 without any OSFA, the addition of OSFA delays the time instant corresponding to the peak of hydration heat and reduces the magnitude of the peak hydration heat when the OSFA content increases from 0 to 60% by the total volume of binder. The shift of the time corresponding to the peak of hydration heat and the change of the magnitude of the peak hydration heat are approximately linear regarding the OSFA content. Such results indicate that the use of the OSFA retards hydration reactions by prolonging the dormant period and hinder the maximum hydration rate. This can be attributed to the high carbon content of the OSFA, as shown in Table Si. The test results of the hydration kinetics support the speculation about the decrease of compressive and flexural strengths when the OSFA content was increased, as discussed in Section 3.2. The OSFA is less reactive compared with the Type I Portland cement.

### Thermogravimetry Analysis

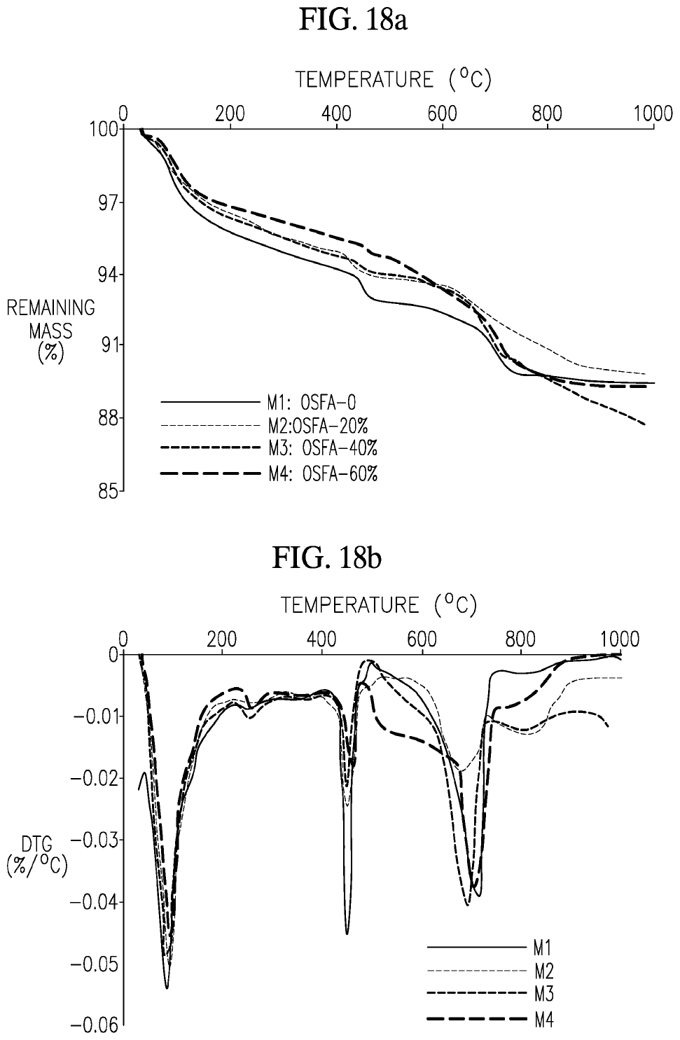

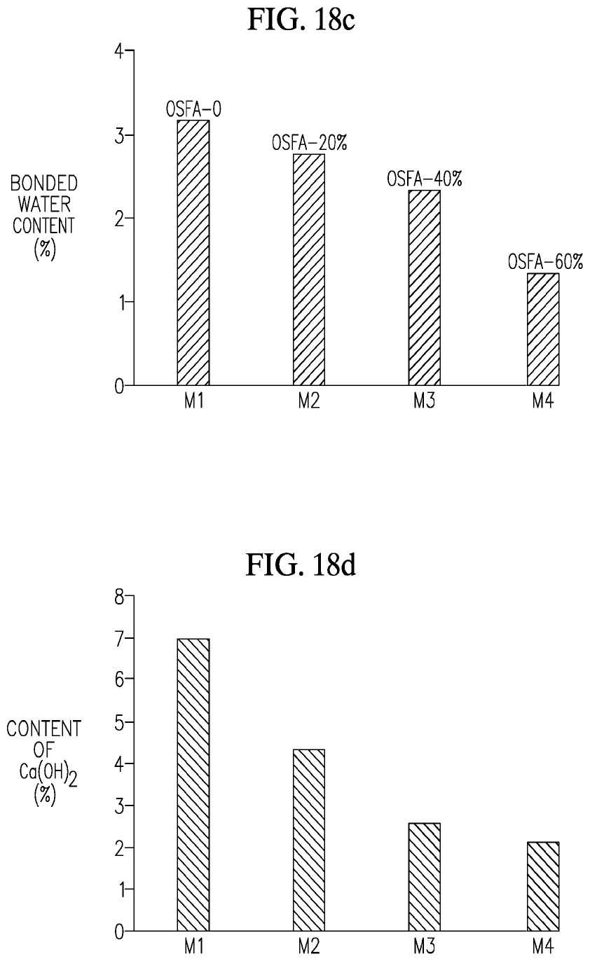

FIGS. 18a-18d shows the TGA test results for mixtures M1 to M4 at 28 days. As the temperature in the heating chamber increased from room temperature to 1000° C., the mass of sample monotonically decreased. The decrease of mass is due to vaporization of water and decomposition of hydration products. The derivative thermogravimetry (DTG) curve of each sample exhibited three peaks at temperatures 90° C., 450° C., and 700° C. The peak at 90° C. is attributed to the dehydration of C-S-H, ettringite, and AFm; the peak at 450° C. is because of the decomposition of calcium hydroxide; and the peak at 700° C. is due to the decomposition of fly ash and calcium carbonate. Based on the percentages of mass losses, the bonded water and calcium hydroxide can be quantitatively evaluated, as shown in FIG. 18c and FIG. 18d.

Compared with the control mixture M1, the bonded water and calcium hydroxide content were reduced in the mixtures blended with the OSFA. As the OSFA content increased from 0 to 60%, the bounded water and calcium hydroxide contents were reduced by 57% and 70%, respectively. The reduction trend of calcium hydroxide amount is related to the retarded hydration reaction as proven by the hydration heat flow discussed in the section immediately above.

### X-Ray Diffraction

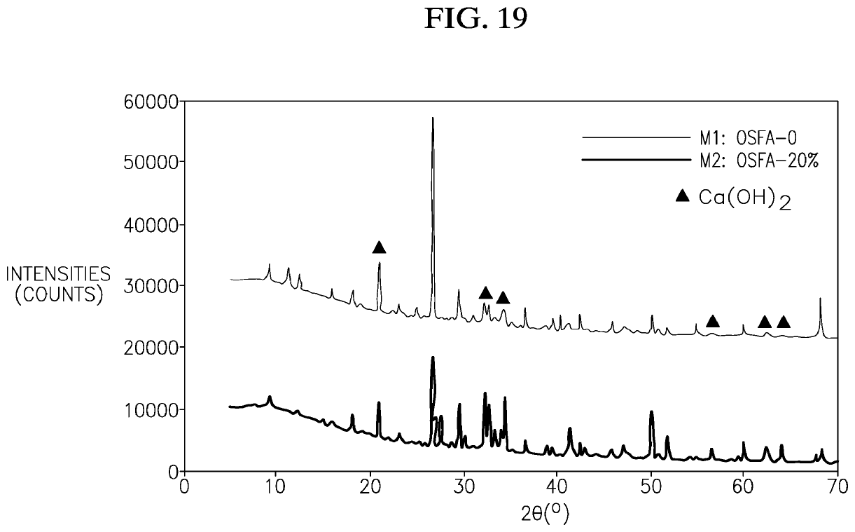

FIG. 19 shows the XRD test results of mixtures M1 and M2 at 28 days. The crystal phases mainly included quartz, calcium hydroxide, ettringite, and unhydrated cement clinkers such as C3S and C2S. The characteristic peaks of calcium hydroxide include 20=18.1°, 34.10, 36.5°, 56.3°, 62.5°, and 62.4° which are marked with a green rectangle above the peaks. Compared with mixture M1 without OSFA, mixture M2 with 20% OSFA showed a lower intensity at the peaks corresponding to calcium hydroxide, indicating that incorporation of the OSFA hindered hydration reaction producing calcium hydroxide. Such results are consistent with the results from the TGA test and the measured kinetics of hydration heat.

### Carbon Footprint

The carbon footprint of each mixture can be calculated using Eq. (5):

$$C = {\sum }_{i = 1}^{n} {c}_{i} {r}_{i} \qquad ( 5 )$$

where C is the carbon footprint of a mixture; ci is the unit carbon footprint of the i-th ingredient of the mixture (i=1, 2, 3, . . . , n, and n=7), as listed in Table S4; and ri is the mass of the i-th ingredient of the mixture, as listed in Table S2.

TABLE S4
Inventory of unit cost, carbon footprint,
and embodied energy of raw materials

| | | | Carbon emission | Embodied energy |
|---|---|---|---|---|
| No. | Ingredient | Cost ($/kg) | (kg/kg) | (MJ/kg) |
| 1 | Cement | 0.11 | 0.83 | 4.73 |
| 2 | OSFA | 0.00 | 0.00 | 0.00 |
| 3 | Silica sand | 0.02 | 0.01 | 0.11 |
| 4 | HR WR | 3.60 | 0.72 | 18.30 |
| 5 | Water | 0.00 | 0.00 | 0.01 |
| 6 | PVA fiber | 4.76 | 1.49 | 20.56 |

Table S4 lists the unit cost, carbon footprint, and embodied energy of the raw materials adopted in this research. The unit cost, carbon emission, and embodied energy of the OSFA are assumed to be zero, because currently the OSFA is mainly treated as a solid waste that is landfilled, and landfill typically involves additional costs, carbon emission, and energy consumption that are not considered in this study. In this sense, utilizing OSFA in SHCC can help avoid the cost, carbon emission, and energy consumption associated with landfill. To be conservative, those benefits are not considered in the following calculations of this study.

With the inventory data, the unit cost of each mixture can be calculated using Eq. (6):

$$M = {\sum }_{i = 1}^{n} {m}_{i} {r}_{i} \qquad ( 6 )$$

where M is the unit cost of a mixture per cubic meter (unit: $/m³); mi is the unit cost (unit: $/kg) of the i-th ingredient of the mixture (i=1, 2, 3, . . . , n, and n=7), as listed in Table S3; and ri is the mass of the i-th ingredient of the mixture (unit: kg/m³), as listed in Table S2.

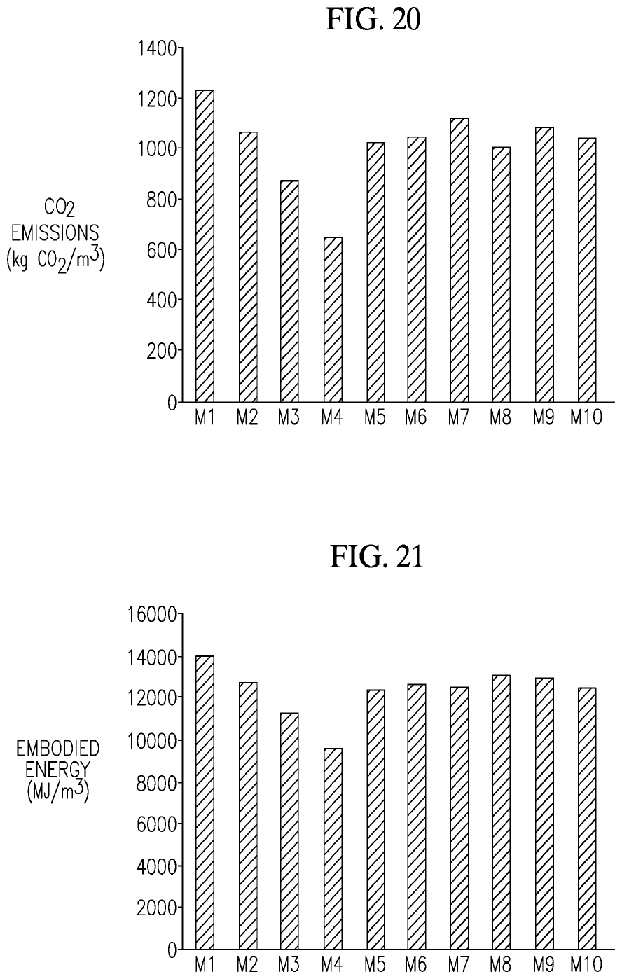

FIG. 20 presents the results of the unit carbon footprint of the investigated mixtures. As the OSFA content increases from 0 to 60%, the unit carbon footprint is reduced from 1229 kg C02/m³ to 653 kg C02/m³ (by 47%). As the fiber content decreases from 2% (M2) to 1% (M5), the unit carbon footprint is reduced from 1062 kg to 1028 kg. As w/b decreases from 0.30 (M8) to 0.22 (M7), the unit carbon footprint is increased from 1010 kg to 1019 kg. As s/b decreases from 0.40 (M10) to 0.32 (M9), the unit carbon footprint is increased from 1041 kg to 1082 kg. Compared with the control mixture M1 without OSFA, mixture M4 shows highest reduction of unit carbon footprint (by 46%), and mixture M2 with highest ductility reduces the unit carbon footprint by 13%.

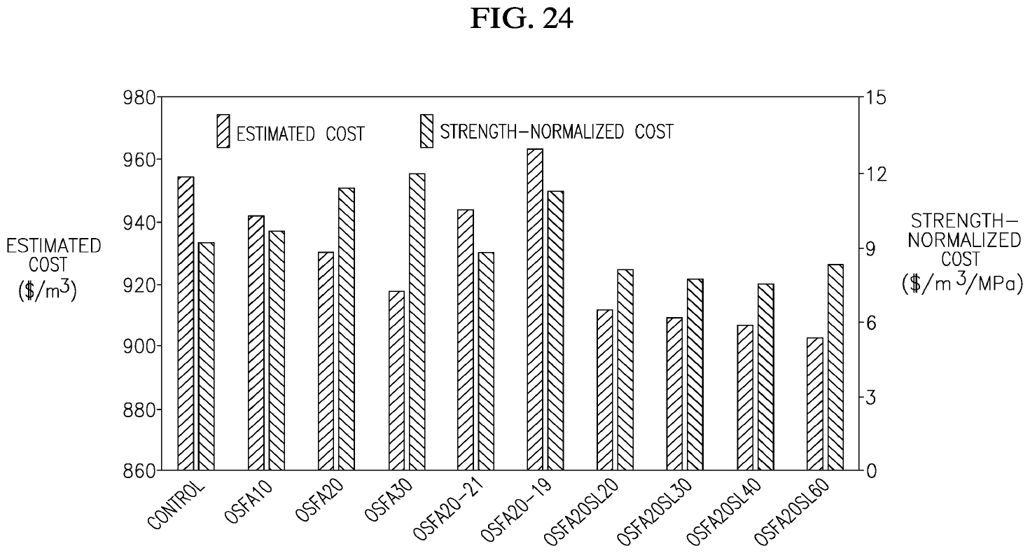

FIG. 24 presents the results of unit cost of the investigated mixtures. As the OSFA content increased from 0 to 30%, the unit cost was reduced from $954 to $917, and the strength-normalized cost was increased from 9.1 $/m³/MPa to 11.9 $/m³/MPa, because the use of OSFA reduced the compressive strength. As the water-to-binder ratio decreased from 0.23 to 0.19, the unit cost was increased from $954 to $963, while the strength-normalized cost was first reduced and then increased. OSFA20-21 achieved the lowest strength-normalized cost, because OSFA20-21 had a high compressive strength. As the slag content increased from 0 to 60%, the unit cost was reduced from $930 to $902, while the strength-normalized cost was sustained at a low value (7.5 8.2 $/m³/MPa). Compared with the control mixture, the use of OSFA and slag reduced the unit cost, and the combination use of OSFA, and slag reduced both the unit cost and strength-normalized cost. Currently, the proprietary UHPC product has a unit cost of about 2500-3000 $/m³, and its strength-normalized cost is about 16-20 $/m³/MPa. The unit cost of OSFA20SL40 is 909 $/m³, which is about 30%-6% of the unit cost of the proprietary UHPC. The strength-normalized cost of OSFA20SL40 is 7.5 $/m³/MPa, which is about 38%-47% of the strength-normalized cost of the proprietary UHPC.

### Embodied Energy

The embodied energy of each mixture can be calculated using Eq. (7):

$$E = {\sum }_{i = 1}^{n} {e}_{i} {r}_{i} \qquad ( 7 )$$

Where E is the embodied energy of a mixture; ei is the unit embodied energy of the i-th ingredient of the mixture (i=1, 2, 3, . . . , n, and n=7), as listed in Table S4; and ri is the mass of the i-th ingredient of the mixture, as listed in Table S2.

According to Eq. (7), the unit embodied energy of each mixture was calculated. FIG. 21 presents the results of unit embodied energy. As the OSFA content increased from 0 to 60%, the unit embodied energy was reduced from 13,986 MJ to 9565 MJ (by 32%). As the fiber content decreases from 2% (M2) to 1% (M5), the unit carbon footprint is reduced from 12,711 MJ to 12,379 MJ. As w/b decreases from 0.30 (M8) to 0.22 (M7), the unit carbon footprint is increased from 12,982 MJ to 12,410 MJ. As s/b decreases from 0.40 (M10) to 0.32 (M9), the unit carbon footprint is increased from 12,461 MJ to 12,966 MJ. Compared with the control mixture M1 without OSFA, mixture M4 shows highest reduction of unit carbon footprint (by 31%), and mixture M2 with highest ductility reduces the unit carbon footprint by 9%.

### Leaching of Heavy Metal Leachability

The TCLP test results for leaching of heavy metals are presented in Table 3. The results show that concentrations of leached heavy metals from the OSFA and SHCC mixtures are lower than the allowable limits, which indicates that the SHCC mixtures prepared with the OSFA do not cause hazardous concerns. Noteworthy, the concentrations of As and Se from the SHCC samples are lower than those from the OSFA samples, which implies that SHCC mixtures are capable of immobilizing heavy metals. The immobilization could be attributed to the capability of the SHCC matrix that binds heavy metals and the dense microstructure of the SHCC matrix that hinders transportation of heavy metals.

TABLE 3
Leachability of heavy metals in TCLP tests

| Designations | As (ppm) | Pb (ppm) | Se (ppm) |
|---|---|---|---|
| OSFA | 0.78 | <0.1 | 0.22 |
| M1 | <0.1 | <0.1 | <0.1 |
| M2 | <0.1 | <0.1 | <0.1 |
| M3 | <0.1 | <0.1 | <0.1 |
| M4 | <0.1 | <0.1 | <0.1 |
| M5 | <0.1 | <0.1 | <0.1 |
| M6 | <0.1 | <0.1 | <0.1 |
| M7 | <0.1 | <0.1 | <0.1 |
| M8 | <0.1 | <0.1 | <0.1 |
| M9 | <0.1 | <0.1 | <0.1 |
| M10 | <0.1 | <0.1 | <0.1 |
| Allowable limits | 5 | 5 | 1 |

### CONCLUSION

Based on the above investigations, the following conclusions are drawn:

First, The OSFA can be utilized to produce SHCC mixtures. With a fiber content of 2%, water-to-binder ratio of 0.26, and sand-to-binder ratio of 0.36, using the OSFA to replace 20% Portland cement can increase the flexural strength from 8.5 MPa to 9.6 MPa (by 13%) and the ultimate deflection from 11.2 mm to 15.5 mm (by 29%) while retaining a reasonable compressive strength (66 MPa) and desired strain-hardening behaviors with dense microcracks.

Next, the addition of OSFA improves the flowability of SHCC mixtures. As the OSFA content increased from 0 to 60%, the mini-slump spread was increased from 244 mm to 325 mm (by 33%), and the plastic viscosity was decreased from 0.66 MP s to 0.38 MP s (by 42%). The improvement of flowability and reduction of the plastic viscosity can be attributed to the finer particles of OSFA compared with that of cement.

Additionally, the use of OSFA reduced the compressive strength of SHCC mixtures. As the OSFA content increased from 0 to 60%, the compressive strength was reduced from 75.8 MPa to 44.2 MPa (by 42%). The reduction in the compressive strength is because the OSFA has a high carbon content and low reactive oxides (i.e., SiO2, CaO, and Al₂O₃) that can dilute the cementitious materials, thus retarding the hydration reactions and hindering the development of microstructures, as corroborated by the data from the hydration kinetics, TGA, and XRD tests.

Furthermore, as the fiber content decreased from 2% to 1%, the compressive and flexural strengths were increased, but the ductility was reduced. As w/b decreased from 0.30 to 0.22, the compressive and flexural strengths were increased consistently, but the ductility was first increased and then reduced. As s/b decreased from 0.40 to 0.32, the compressive and flexural strengths were increased consistently, but the ductility was first increased and then reduced.

Finally, based on the economic and environmental evaluation, the developed SHCC mixtures with OSFA demonstrated significant benefits from the perspective of economy and sustainability. Compared with the control mixture without any OSFA, the use of 20% OSFA reduces the unit cost, carbon footprint, and embodied energy by 5%, 9%, and 13%, respectively. The leaching of heavy metals from SHCC with OSFA is lower than the allowable upper limits.

It is speculated that the use of OSFA can significantly alter the electrical resistance and thermal conductivity of SHCC because of the electrical and thermal properties of carbon. More experiments are needed to test the speculation and understand the effects on applications for engineering structures, such as the corrosion resistance of members made using SHCC and steel bars.

Additionally, the effects of the developed SHCC blended with OSFA on the mechanical properties of engineering structures should be investigated. It is envisioned that the SHCC can greatly improve the flexural strength, ductility, and toughness of structural members subjected to extreme mechanical loads, such as impacts and earthquakes.

Further embodiments and details relating to the present invention can be found in the publications entitled “Utilization of off-specification fly ash in preparing ultra-high-performance concrete (UHPC): mixture design, characterization, and life-cycle assessment’ and “Utilization of Off-specification Fly Ash In Preparing Strain-hardening Cementitious Composites (SHCC): Key Properties and Environmental Impact,” the entire contents of both of which are incorporated herein by reference and made a part of the present application for all purposes

It will be understood that the embodiments described herein are merely exemplary and that a person skilled in the art may make many variations and modifications without departing from the spirit and scope of the invention. All such variations and modifications are intended to be included within the scope of the invention.

What is claimed is:

1. A method for making concrete, comprising the steps of:
providing a composition which includes cement and slag;
adding off-specification fly ash to said composition;
introducing a high-range water reducer and water mixture to said composition;
supplying said composition to a mixer; and
continuously mixing said composition in said mixer.

2. The method of claim 1, further comprising the step of adding fibers to said composition.

3. The method of claim 2, wherein said fibers make up from about 1% to about 2% of said concrete.

4. The method of claim 1, wherein said fibers are steel fibers.

5. The method of claim 4, wherein said steel fibers are approximately 0.2 mm in diameter and approximately 13 mm in length.

6. The method of claim 4, wherein the tensile strength and modulus of elasticity of said steel fibers are approximately 1.9 GPa and 203 GPa, respectively.

7. The method of claim 1, wherein said fibers are polyvinyl alcohol fibers.

8. The method of claim 7, wherein said polyvinyl alcohol fibers are approximately 12 mm in length.

9. The method of claim 1, further comprising the step of adding sand to said composition as a fine aggregate.

10. The method of claim 9, wherein said sand is masonry sand.

11. The method of claim 9, wherein said sand includes silica.

12. The method of claim 9, wherein said sand is added simultaneously with said off-specification fly ash.

13. The method of claim 9, wherein said sand is added simultaneously with said cement.

14. The method of claim 9, wherein said sand is added simultaneously with said slag.

15. The method of claim 1, wherein said high-range water reducer has a solid content of approximately 34.4%

16. The method of claim 1, wherein the specific gravity of said high-range water reducer is approximately 1.05.

17. The method of claim 1, wherein said high-range water reducer is a polycarboxylate based compound.

18. The method of claim 1, further comprising the steps of curing and hardening said composition into concrete.

19. The method of claim 1, wherein said concrete is self-flowable.

20. The method of claim 1, wherein said concrete has self-healing properties.

21. The method of claim 1, wherein said cement and said slag are added simultaneously with said off-specification fly ash.

22. The method of claim 1, wherein said cement is Type 1 Portland cement.

23. The method of claim 1, wherein said concrete has a water-to-binder ratio of approximately 0.26.

24. The method of claim 1, wherein said concrete has a water-to-binder ratio of between 0.19 to 0.23.

25. The method of claim 9, wherein said concrete has a sand-to-binder ratio of approximately 0.36.

26. The method of claim 1, wherein said concrete has a cracking strength at least twice that of standard concrete.

27. The method of claim 1, wherein said concrete has self-sensing properties.

28. The method of claim 1, wherein said off-specification fly ash ranges from 10% to 30% by volume of binder of said concrete.

29. The method of claim 28, wherein said off-specification fly ash is approximately 10% by volume of binder of said concrete.

30. The method of claim 28, wherein said off-specification fly ash is approximately 20% by volume of binder of said concrete.

31. The method of claim 28, wherein said off-specification fly ash is approximately 30% by volume of binder of said concrete.

32. The method of claim 1, wherein said off-specification fly ash is between 20% to 60% by volume of binder of said concrete.

33. The method of claim 1, wherein said slag ranges from 20% to 60% by composition of said concrete.

34. The method of claim 1, wherein a water to binder ratio of said concrete ranges from 0.22 to 0.30.

35. The method of claim 1, wherein a sand to binder ratio of said concrete ranges from 0.32 to 0.40.

36. The method of claim 1, wherein said introducing step takes place after said adding step.

37. A high-performance concrete material, comprising: cement, slag, sand, high-range water reducer mixed with water, off-specification fly ash, and fibers.

38. The concrete material of claim 37, further comprising chemical admixtures.

39. The concrete material of claim 38, wherein said chemical admixtures comprise a polycarboxylate-based high-range water reducer.
